(19) United States
(12) Patent Application Publication
(10) Pub. No.: US 2024/0428988 A1
(43) Pub. Date: Dec. 26, 2024

(54) TRANSFORMER FOR CONTROLLING INDEPENDENT ACTIVE AND REACTIVE POWER FLOWS IN A TRANSMISSION LINE

(71) Applicant: SEN ENGINEERING SOLUTIONS, INC., Monroeville, PA (US)

(72) Inventors: Kalyan K. SEN, Monroeville, PA (US); Mey Ling SEN, Monroeville, PA (US)

(73) Assignee: SEN ENGINEERING SOLUTIONS, INC., Monroeville, PA (US)

(21) Appl. No.: 18/492,817

(22) Filed: Oct. 24, 2023

Related U.S. Application Data
(60) Provisional application No. 63/509,113, filed on Jun. 20, 2023.

(51) Int. Cl. H01F 29/04; H01F 27/00; H01F 29/02; H02J 3/18

(52) U.S. Cl. CPC H01F 29/04; H01F 27/006; H01F 29/025; H02J 3/1878

(57) ABSTRACT

An exemplary transformer includes an exciter unit (EU) and a compensating voltage unit (CVU). The EU including a three-phase transformer with shunt Y-connected primary windings. The CVU includes plural series-connected secondary windings having one secondary winding from each phase of the EU, and plural load tap changers. Each load tap changer is associated with a group of secondary windings that includes one secondary winding from each phase of the EU. Each secondary winding in a group of secondary windings is located at a same distance from an associated primary winding of the EU. All secondary windings, sub-windings between two consecutive taps, and primary windings have similar heights. Sub-windings may or may not be interleaved. Each load tap changer can vary an effective number of turns of the associated group of secondary windings by connecting to one of plural taps associated with each secondary winding according to a selected operating point.

### FIELD

The present disclosure relates to a transformer, and more particularly to a transformer that generates a compensating voltage.

### BACKGROUND

In the past, electrical engineering technology implemented power flow control techniques using inductors, capacitors, transformers and load tap changers. In recent years, power electronics-based solutions are the preferred means for addressing power flow control schemes. Power flow control solutions can vary widely in cost and complexity from building new transmission lines to utilizing the existing transmission lines more efficiently. An important consideration for any solution is identifying the underutilized transmission lines and harness their dormant capacities to increase the power flows to the lines' thermal limits using the most cost-effective and time-tested solutions.

The power flow control in a line is performed either by regulating the effective line reactance with a series-connected capacitor or a reactor in the line and or by regulating the effective phase angle between the voltages at the sending and receiving ends of the line. In either case, the active and reactive power flows in the line change simultaneously, which means that the active and reactive power flows cannot be controlled independently.

An independent control of active and reactive power flows in the line as desired can only be realized by emulating an independently regulated resistance and reactance using an Impedance Regulator (IR).

A realizable Power Flow Controller emulates a four-quadrant impedance (−R, +R, X_{C} and X_{L}) using a compensating voltage that is at any phase angle with the line current flowing through it. The ratio of the compensating voltage and the prevailing line current is the emulated impedance. This compensating voltage exchanges active and reactive powers with the line. For the exchanged power to flow freely, the compensating voltage is linked with either a shunt-connected voltage to the same line as in case of a power electronics-based Unified Power Flow Controller, electric machine-based Rotary Transformer and transformers/LTC-based Sen Transformer or series-connected voltage as in case of a power electronics-based Interline Power Flow Controller or transformers/LTC-based Multiline Sen Transformer. In special cases, when the compensating voltage and the line current that flows through it are in quadrature, the compensating voltage that is made out of power electronics-based or electric machine-based, does not need to be linked with another voltage source. These special cases are equivalent to using a capacitor or a reactor for compensation.

U.S. Pat. No. 7,835,128 proposes a Distributed Series Reactor (DSR) that inserts a magnetizing inductance of a transformer into a conductor when the conductor current reaches a predetermined value and removes the magnetizing inductance when the conductor current returns below the predetermined value. The disclosed method inserts a reactor in series with the line and only reduces the power flow in the line. Because a capacitor cannot be inserted in series with the line using this method, the system cannot increase the power flow in the line. Also, this system does not implement −R or +R; therefore, it is not an Impedance Regulator and cannot control the active and reactive power flows in the line independently.

U.S. Pat. No. 5,198,746 discloses a technique that emulates a series capacitor or a reactor by connecting a compensating voltage in series with the line and maintaining its phase angle at 900 lagging or leading the prevailing line current. Through control action, the magnitude of the series-compensating voltage is varied in order to vary the emulated capacitor or reactor. A variable magnitude, series-compensating voltage was proposed to be implemented through the use of power electronics inverters. Impedance compensation is achieved based on using an energy storage across the DC capacitor of the inverter so that additional active power can be exchanged with the line on a transient basis. Impedance compensation depends on the rating of the storage device; therefore, its duration of operation is limited. An impedance compensation on a continuous basis is needed for a Power Flow Controller that is capable of implementing a four-quadrant impedance and controlling active and reactive powers independently. The disclosed technique also uses a reactance control method that is used to operate the Reactance Regulator (RR) so that the series-compensating voltage (V_{s′s}) is proportional to the prevailing line current (I) with the emulated reactance (Xₛₑ) being the constant of proportionality. For this control algorithm to work successfully, a line current must exist. Also, in the reactance control method, the polarity of the reactance is defined before the desired control action is to take place. If it is defined to be inductive, the most that can be achieved is the reduction of the line current to somewhat lower than the corresponding uncompensated value. The line current can never be brought to nearly zero by the controller since the successful operation of the control algorithm depends on the existence of the line current. If the emulated reactance is to be defined as capacitive, the line current, at first, increases. If the emulated capacitive reactance demand is higher than the line inductive reactance, the effective line reactance becomes capacitive and the power flow in the line reverses. But reversing the power flow while the line current is high, causes a number of problems. During the transition, when the power flow reverses, the line may operate beyond its maximum thermal capability. Also, during the emulation of a higher capacitive reactance, there exists a point at which the inductive reactance of the line and the capacitive reactance emulated by the Reactance Regulator become equal, which can cause instability in the power flow of the line. The reactance control method provides the basic features of the RR in terms of decreasing or increasing the power flow in the line. However, the undesirable feature of this control method appears during the reversal of power flow in the line when the line current is too high and causes even higher transients. In a practical implementation, if the current through the RR exceeds its rating, the inverter-based RR will be bypassed.

U.S. Pat. No. 5,754,035 discloses a voltage control method that offers all the desirable features offered by the reactance control method in terms of controlling the power flow in the line. In addition, the voltage control method offers an absolute stability in the power flow, causing the power to go through near zero while changing its direction of flow.

U.S. Pat. No. 9,197,065 discloses a Phase Angle Regulator (PAR) that provides a series-compensating voltage that is at ±90° relative phase angle with the line voltage. The purpose of a PAR is to regulate the phase-shift angle of the line voltage in order to control the power flow in the line; however, the phase angle regulation cannot control the active and reactive power flows in the line independently. The PAR's inability to use the relative phase angle in the range of 0° to 360°, other than ±90°, precludes it to facilitate the active and reactive power flows independently. A power electronics-based PAR can provide dynamic compensation in milliseconds as power electronics-based Impedance Regulator (Unified Power Flow Controller) demonstrated at American Electric Power's Inez substation in 1998. In contrast, the dynamic performance of a PAR is limited by the speed of operation of the mechanical LTCs, which respond in seconds; however, this level of response time has been acceptable in most utility applications for decades.

A PAR injects a compensating voltage in series with the line and, thereby, emulates a compensating impedance that is the ratio of the compensating voltage and the prevailing line current. However, this emulated impedance is not an independently regulated resistance and reactance; therefore, a PAR cannot control the active and reactive power flows in the line independently, whereas an Impedance Regulator (IR) offers an independent control of active and reactive power flows in the line as desired.

U.S. Pat. No. 5,841,267 discloses independent control of active and reactive power flows such that the compensating voltage was generated using electrical machines.

U.S. Pat. No. 8,054,011 discloses an independent active and reactive power flow controller that is electric machine based. The machine uses a shunt-shunt configuration, which results in the power rating and cost being much higher than an equivalent shunt-series Power Flow Controller.

FIG. 1 illustrates a Sen Transformer in accordance with a known implementation. U.S. Pat. Nos. 6,335,613; 6,384,581; 6,396,248; and 6,420,856 disclose a Sen Transformer in a Shunt-Series configuration that is used as a versatile power flow transformer for compensating power flow in a transmission line. The Sen Transformer provides independent control of active and reactive power flows, using an IR in a low-cost way by using redesigned transformer/LTC technology. The reason is that the transformer/LTC technology has been proven to be efficient, simple and reliable in utility applications for decades. The Sen Transformer uses three primary windings and nine secondary windings to create a compensating voltage that modifies the line voltage to be a specific magnitude and phase angle, whereas the conventional transformer only modifies the magnitude of the line voltage, and a PAR modifies only the phase angle of the line voltage. As a result, by using a Sen Transformer, the active and reactive power flows in the line can be regulated independently to maximize the revenue-generating active power flow and minimize the reactive power flow while maintaining the stability of the line voltage.

Transformers used in power system applications typically include two types: Voltage-Regulating Transformer (VRT) and Phase Angle Regulator (PAR). The VRT primarily regulates the magnitude of the line voltage (i.e., increase or decrease of the line voltage) without significantly changing its original phase angle. In a symmetric configuration, the PAR (sym) primarily regulates the phase angle of the line voltage with little or no change in its original voltage magnitude. In an asymmetric configuration, the PAR primarily regulates the phase angle of the line voltage with some increase in the magnitude of the line voltage.

FIGS. 2A and 2B illustrate Voltage-Regulation Transformers in accordance with known implementations. The VRT can be of two kinds: (a) autotransformer 202 as shown in FIG. 2A and (b) two-winding transformer 204 as shown in FIG. 2B. Because a transformer is configured to transform electrical energy from one voltage and current level at its input to another voltage and current level at its output, if the primary voltage (vₚ) is applied across the primary winding with nₚ turns and the secondary voltage (vₛ) is induced across the secondary winding with nₛ turns, an ideal transformer operates with the following principle:

$$\frac{{v}_{p}}{{n}_{p}} = \frac{{ν}_{s}}{{n}_{s}} \qquad ( 1 )$$

Depending on the configuration of the transformer, the output voltage (vₒᵤₜ) is related to the input voltage (vᵢₙ) as

$${v}_{out} = {v}_{p} + {v}_{s} = {v}_{p} \times ( 1 + \frac{{n}_{s}}{{n}_{p}} ) = {v}_{in} \times ( 1 + \frac{{n}_{s}}{{n}_{p}} ) \qquad ( 2 )$$

$${ν}_{o u t} = {v}_{s} = {ν}_{p} \times \frac{{n}_{s}}{{n}_{p}} = {v}_{in} \times \frac{{n}_{s}}{{n}_{p}} \qquad ( 3 )$$

Where primary voltage (vₚ) is applied across the primary winding with nₚ turns and the secondary voltage (vₛ) is induced across the secondary winding with nₛ turns. The input current (iᵢₙ) is related to the output current (iₒᵤₜ) as

$${i}_{in} = {i}_{s} + {i}_{p} = {i}_{s} \times ( 1 + \frac{{n}_{s}}{{n}_{ρ}} ) = {i}_{out} \times ( 1 + \frac{{n}_{s}}{{n}_{ρ}} ) \qquad ( 4 )$$

$${i}_{in} = {i}_{p} = {i}_{s} \times \frac{{n}_{s}}{{n}_{p}} = {i}_{out} \times \frac{{n}_{s}}{{n}_{p}} \qquad ( 5 )$$

using the fact that the magnetomotive force is balanced in the primary and secondary windings as

$${n}_{p} \times {i}_{p} = {n}_{s} \times {i}_{s} \qquad ( 6 )$$

In both configurations of FIGS. 2A and 2B, it can be verified from Equations (2), (3), (4) and (5) that input power is the same as the output power. In other words,

$${ν}_{in} \times {i}_{in} = {v}_{out} \times {i}_{out} \qquad ( 7 )$$

In a two-winding transformer, the primary and secondary voltages are electrically isolated. The induced voltage in the secondary winding is connected in shunt with the line. For a voltage step-up transformer, nₛ>nₚ. This is useful to increase the voltage from the output of a generator before transmitting electrical energy through high voltage alternating current transmission lines. For a voltage step-down transformer, nₛ<nₚ. This is useful to decrease the voltage of a transmission line before its use at various lower voltages required by loads. When nₚ=nₛ, the primary and the secondary voltages and currents are the same and the transformer is used as an isolation transformer, since the primary and the secondary voltages are electrically isolated. In both the autotransformer and the two-winding transformer, the active number of turns in the secondary windings are varied with the use of LTCs.

From Equations (1) and (6), it can be written as

$${ν}_{p} \times {i}_{p} = {ν}_{s} \times {i}_{s} \qquad ( 8 )$$

which ensures the power balance in both primary and secondary windings since an ideal transformer neither generates nor absorbs power.

The autotransformer of FIG. 2A is referred to as having a shunt-series configuration, because the exciting (i.e., primary) winding 206ₚ is connected to the line in shunt and the compensating (i.e., secondary) winding 206ₛ is connected to the line in series. The two-winding transformer of FIG. 2B is referred to as having a shunt-shunt configuration, because both the exciting (i.e., primary) winding 208ₚ and the compensating (i.e., secondary) winding 208ₛ are connected to the line in shunt. A shunt-series configuration is electrically connected between the primary and secondary windings; however, a shunt-shunt configuration is electrically isolated between the primary and secondary windings.

FIG. 3 illustrates a transformer circuit according to a known implementation. As shown in FIG. 3, a transformer circuit 300 can include both a Voltage Regulator 302 and a Phase Angle Regulator 304. The Voltage Regulator (VR) or autotransformer 302 regulates the line voltage by connecting a compensating voltage of variable magnitude in series with the line at 0° or 180° with respect to the line voltage. The Phase Angle Regulator (PAR) 304 regulates the phase angle of the line voltage by connecting a compensating voltage of variable magnitude in series with the line at 90° or −90° with respect to the line voltage. The compensating voltage (V₁ₛ) in the autotransformer 302 varies with LTCs 306 in-phase (0°) or out-of-phase (180°) with the line voltage and, therefore, regulates the magnitude of the transmission line voltage. The compensating voltage (V_{s′1}) in the PAR 304 varies with LTCs 308 in quadrature (90° or −90°) with the line voltage and, therefore, regulates the phase angle of the transmission line voltage. FIG. 3 shows how these two orthogonal compensating voltages—V₁ₛ from the autotransformer 302 and V_{s′1} from the PAR 304—can be combined to generate a new compensating voltage (V_{s′s}) that is variable in magnitude and variable in phase angle. The new compensating voltage (V_{s′s}) is not restricted to any particular phase angle, such as 0°, 180°, or ±90°. Because of its variable magnitude and variable phase angle compensating voltage, the line voltage can be modified to be at variable magnitude and phase angle. Creating two orthogonal voltages using an autotransformer and a PAR requires more hardware than what a single unit of Sen Transformer would require for the creation of the same compensating voltage (V_{s′s}).

FIGS. 4A and 4B illustrate a single-line diagram of Sen Transformer and associated phasor diagram, respectively, in accordance with a known implementation. The Sen Transformer 400 combines the functions of an autotransformer and a PAR into a smaller physical package that results in a reduced amount of hardware from what is required separately for an autotransformer and a PAR. As shown in FIG. 4A, the Sen Transformer 400 uses a Shunt Unit (Exciter Unit) 402 and a Series Unit (Compensating-Voltage Unit) 404 and creates a series-compensating voltage (V_{s′s}) that is variable in magnitude (V_{s′s}) and relative phase angle (β) to modify the line voltage from (Vₛ) to (V_{s′}) and controls both magnitude (V_{s′}) and phase-shift angle (ψ) simultaneously in order to achieve an independent control of active and reactive power flows in the line. As shown in FIGS. 4A and 4B, the Sen Transformer 400 regulates the magnitude (V_{s′}) and phase-shift angle (ψ) of the line voltage simultaneously by connecting a compensating voltage of variable magnitude (V_{s′s}) in series with the line at any relative phase angle, 0°≤ρ≤360°.

Turning back to FIG. 1A, the Sen Transformer includes an Exciter Unit 102 and a three-phase transformer with Y-connected primary windings (108A, 108B, and 108C). The Compensating-Voltage Unit 104 includes nine secondary windings (three windings in each phase: 106ₐ₁, 106ₐ₂, and 106ₐ₃ on the core of the A phase; 106_{b1}, 106_{b2}, and 106_{b3} on the core of the B phase; and 106_{c1}, 106_{c2}, and 106_{c3} on the core of the C phase. The compensating secondary windings 106ₐ₁, 106ₐ₂, 106ₐ₃, 106_{b1}, 106_{b2}, 106_{b3}, 106_{c1}, 106_{c2}, and 106_{c3} are allocated in groups arranged in terms of taps at specified intervals. By choosing the number of turns of a group of secondary windings with the use of an LTC 110 associated with the group, the magnitude of the compensating voltage (V_{s′s}) is varied in a specified range and the relative phase angle (β) is varied between 0° to 360°. The three-phase sending-end voltages (V_{sA}, V_{sB}, and V_{sC}) are applied to the Exciter Unit 102. The LTCs change their positions in steps, and in turn the compensating points are discrete in the allowable control range of the relative phase angle of 0≤β≤360°.

The LTCs can be grouped as follows:
106ₐ₁, 106_{b2} and 106_{c3} for the first three-phase LTC1
106_{b1}, 106_{c2} and 106ₐ₃ for the second three-phase LTC2
106_{c1}, 106ₐ₂ and 106_{b3} for the third three-phase LTC3.

That means each of the windings (106ₐ₁, 106_{b2} and 106_{c3}) is tapped at the same number of turns through LTC1; each of the windings (106_{b1}, 106_{c2} and 106ₐ₃) is tapped at the same number of turns through LTC2; and each of the windings (106_{c1}, 106ₐ₂ and 106_{b3}) is tapped at the same number of turns through LTC3. However, the number of turns in the 106ₐ₁-106_{b2}-106_{c3} set, the 106_{b1}-106_{c2}-106ₐ₃ set, and the 106_{c1}-106ₐ₂-106_{b3} set can be different from each other.

By choosing the number of turns from each of the three windings through three LTCs (LTC1, LTC2, and LTC3) and, therefore, the magnitudes of the components of the three 120° phase-shifted induced voltages, the compensating voltage (V_{s′s}) in any phase is derived from the phasor sum of the voltages induced in a three-phase secondary winding set (106ₐ₁, 106_{b1}, and 106_{c1} for compensation in the A phase; 106ₐ₂, 106_{b2}, and 106_{c2} for compensation in the B phase; and 106ₐ₃, 106_{b3}, and 106_{c3} for compensation in the C phase). The magnitude of the induced voltage (V) in a secondary winding, the voltage (x) across each tap of the LTC, and the number (N) of taps in the LTC are related by the following equation:

$$N = \frac{V}{x} \qquad ( 9 )$$

The magnitude (V_{s′s}) and the relative phase angle (β) of the compensating voltage (V_{s′s}) can be calculated in terms of taps associated with a particular phase. The modified sending-end voltage (V_{s′}) is generated by connecting the compensating voltage (V_{s′s}) with magnitude (V_{s′s}) and the relative phase angle (β) in series with the sending-end voltage (Vₛ). This can be written for the A phase as:

$${V}_{{s}^{′} A} = {V}_{s A} + {V}_{{s}^{′} s A} \qquad ( 10 )$$

$$or$$

$${V}_{{s}^{′} A} ∠ {ψ}_{A} = {V}_{s A} ∠0° + {V}_{{s}^{′} s A} ∠ {β}_{A} \qquad ( 11 )$$

$$where$$

$${V}_{{s}^{′} s A} ∠ {β}_{A} = {V}_{{s}^{′} s A} = {V}_{a 1} + {V}_{b 1} + {V}_{c 1} \qquad ( 12 )$$

$$or$$

$${V}_{{s}^{′} s A} ∠ {β}_{A} = {k}_{a 1} {V}_{s A} + {k}_{b 1} {V}_{s B} + {k}_{c 1} {V}_{s C} = {k}_{a 1} {V}_{s A} + {k}_{b 1} {e}^{- j 2 π / 3} {V}_{s A} + {k}_{c 1} {e}^{j 2 π / 3} {V}_{s A} \qquad ( 13 )$$

Where:

Vₐ₁, V_{b1}, and V_{c1} are active voltages in the series-compensating windings (a1, b1, and c1) of the A phase,

kₐ₁=0.05, k_{b1}=0, and k_{c1}=0.20 are the arbitrarily chosen active turns-ratios of the secondary, series-compensating windings in the A phase and the corresponding primary windings,

V_{s′sA} is the magnitude of the series-compensating voltage in the A phase, and

β_{A} is the relative phase angle of the series-compensating voltage in the A phase.

FIGS. 5A to 5F illustrate plural single-phase transformers in accordance with a known implementation. Each single-phase transformer in FIGS. 5A to 5B is an ideal transformer in which an alternating current (AC) source voltage is applied at the input or primary winding and, as a result, an AC current flows in the primary winding. The primary current (iₚ) creates an AC primary magnetic flux (ϕₚ). The primary voltage (vₚ), the primary magnetic flux (ϕₚ) and the number of turns (nₚ) in the primary winding are related, according to Faraday's Law of induction, as

$${v}_{p} = {n}_{p} \frac{d {ϕ}_{p}}{dt} \qquad ( 14 )$$

In reality, an ideal transformer does not exist because a part of the primary magnetic flux (ϕₚ), which is referred to as leakage primary magnetic flux (#ₗₚ), does not flow through the magnetic core. The remaining part is referred to as mutual magnetic flux (ϕₘ) as illustrated in FIG. 5C.

The difference between the two voltages—primary voltage (vₚ) and the modified primary voltage (v′ₚ), is represented as a voltage (vₗₚ) across the leakage primary reactance (Xₗₚ) as illustrated in FIG. 5D. To account for the leakage primary magnetic flux (ϕₗₚ), a part of the exciting primary voltage is considered across an equivalent leakage primary reactance (Xₗₚ) inside the transformer before the ideal transformer action takes place.

The primary winding acts as a load to the source. The secondary winding acts as a source to the load. When the secondary winding supplies current to a load the polarity of the current in the secondary winding would be such that the magnetic flux produced by the secondary current (iₛ) would oppose the mutual magnetic flux (ϕₘ). In order to maintain the same mutual flux, the primary current (iₚ) increases when the secondary current (iₛ) increases. A part of the secondary magnetic flux (ϕₛ) that does not flow through the magnetic core is referred to as secondary leakage magnetic flux (ϕₗₛ) that opposes the mutual magnetic flux (ϕₘ) as illustrated in FIG. 5E.

The difference of the two voltages—modified secondary voltage (v′ₛ) and the secondary voltage (vₛ), is represented as a voltage (vₗₛ) across the leakage secondary reactance (Xₗₛ). To account for the leakage secondary magnetic flux (ϕₗₛ), a part of the induced secondary voltage is considered across an equivalent leakage secondary reactance (Xₗₛ) inside the transformer before the remaining voltage is available at the output terminals as illustrated in FIG. 5F.

FIGS. 6A to 6C illustrate three single-phase transformers in accordance with a known implementation. As shown in FIG. 6A three single-phase transformers 602A, 602B, and 602C are excited with a three-phase primary voltage (v_{pA}, v_{pB}, and v_{pC}) where each phase voltage is displaced by a phase angle of 1200; in the induced three-phase secondary voltage (v_{sA}, v_{sB}, and v_{sC}), each phase voltage is also displaced by a phase angle of 1200. The turns in the primary and secondary windings in each phase are n_{pA} and n_{sA}, n_{pB} and n_{sB}, and n_{pC} and n_{sC}, respectively. FIGS. 6B and 6C illustrate the single-phase transformers of FIG. 6A arranged as a three-phase transformer 604 where there is only one primary winding and one secondary winding on each leg of the core 606, the leakage impedance in each phase is the same and the voltage across the leakage impedance in each phase is the same.

FIGS. 7A and 7B illustrate one three-phase transformer in accordance with another known implementation. As shown in FIGS. 7A and 7B, each leg of the core has a single primary winding and secondary winding in a nested arrangement where the primary and secondary windings are concentric about each core leg. Even in a nested and concentric arrangement, the one primary winding and one secondary winding on each leg of the core results in the leakage impedance in each phase being the same regardless of whether the primary winding is the inner winding, which is placed next to the core, and the secondary winding is the outer winding as illustrated in FIG. 7A or vice versa as illustrated in FIG. 7B. In general, a lower voltage winding may be placed next to the core and a higher voltage winding may be placed further away from the core. However, if a winding consists of taps, it may be a better design to place the winding outside, regardless of its voltage because of other benefits, such as an easy access to the taps. As shown in FIGS. 7A and 7B, all primary windings in the transformer have the same internal diameters (IDs) and outer diameters (ODs). Also, all the secondary windings in the transformer have the same IDs and ODs.

Sen Transformers can have an arrangement in which at least multiple secondary windings can be placed on each leg of the core. For this arrangement special care must be taken to make the leakage impedance in each phase the same so that the voltage across the leakage impedance is balanced in each phase; otherwise, the voltage in the three phases at the output would result unbalanced, which is not desirable. Also, the compensating voltage in each of the three phases be equal in magnitude and be displaced by a phase angle of 120°.

### SUMMARY

An exemplary transformer that generates a compensating voltage is disclosed, the transformer comprising: an Exciter Unit; and a Compensating-Voltage Unit, the Exciter Unit including three single-phase transformers or a three-phase transformer with shunt Y-connected primary windings, the Compensating-Voltage Unit including: plural series-connected secondary windings that includes one secondary winding from each phase of the Exciter Unit; and plural load tap changers, wherein each load tap changer is associated with a group of secondary windings that includes one secondary winding from each phase of the Exciter Unit, wherein each secondary winding in a group of secondary windings is located at a same distance from an associated primary winding of the Exciter Unit, wherein all secondary windings and sub-windings between two consecutive taps and primary windings have similar heights, the sub-windings may or may not be interleaved, and wherein each load tap changer is configured to vary an effective number of turns of the associated group of secondary windings by connecting to one of plural taps associated with each secondary winding according to a selected operating point.

An exemplary method of generating a compensating voltage through a transformer is disclosed, the transformer having an Exciter Unit and a Compensating-Voltage Unit, including three single-phase transformers or a three-phase transformer with shunt Y-connected primary windings, the Compensating-Voltage Unit including: plural series-connected secondary windings that includes one secondary winding from each phase of the Exciter Unit; and plural load tap changers, wherein each load tap changer is associated with a group of secondary windings that includes one secondary winding from each phase of the Exciter Unit, wherein each secondary winding in a group of secondary windings is located at a same distance from an associated primary winding of the Exciter Unit, wherein all secondary windings and sub-windings between two consecutive taps and primary windings have similar heights, the sub-windings may or may not be interleaved, the method comprising: selecting an operating point of the transformer; selecting a load tap position for each secondary winding in the group of secondary windings associated with each load tap changer based on the operating point; and generating a compensating voltage by summing effective voltages induced in the group of secondary windings for each load tap changer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Exemplary embodiments are best understood from the following detailed description when read in conjunction with the accompanying drawings. Included in the drawings are the following figures:

FIGS. 1A and 1B illustrate a Sen Transformer in a Shunt-Series configuration and the related phasor diagram in accordance with a known implementation.

FIGS. 2A and 2B illustrate Voltage-Regulation Transformers, namely Autotransformer and Two-Winding Transformer, respectively, in accordance with known implementations.

FIG. 3 illustrates a transformer circuit, integrating an Autotransformer and a Phase Angle Regulator (asymmetric), according to a known implementation.

FIGS. 4A and 4B illustrate a single-line diagram of Sen Transformer in a Shunt-Series configuration and the associated phasor diagram, respectively, in accordance with a known implementation.

FIGS. 5A, 5C and 5E illustrate plural single-phase transformers and their equivalent circuit diagrams in FIGS. 5B, 5D and 5F, respectively, in accordance with a known implementation.

FIG. 6A illustrates three single-phase transformers in accordance with a known implementation.

FIGS. 6B and 6C illustrate one three-phase transformer in accordance with a known implementation.

FIG. 7A illustrates an arrangement of primary windings (closest to the core) and secondary windings in accordance with a known implementation.

FIG. 7B illustrates an arrangement of primary windings and secondary windings (closest to the core) in accordance with a known implementation.

FIGS. 8A to 8P illustrate exemplary winding arrangements for a Sen Transformer according to an exemplary embodiment of the present disclosure.

FIGS. 9A and 9B illustrate modified sending-end voltages operating points and the respective active and reactive power flows (Pᵣ and Qᵣ) operating points, numbered 0 through 60, in accordance with an exemplary embodiment of the present disclosure.

FIGS. 9C to 9AC illustrate the maximum active power flow enhancement doubling capability of the Sen Transformer in accordance with an exemplary embodiment of the present disclosure.

FIGS. 10A to 10E are tables showing operating points of the Sen Transformer in accordance with an exemplary embodiment of the present disclosure.

FIG. 11 illustrates an exemplary winding layout and a distribution of Ampere-Turns at β=0° in accordance with an exemplary embodiment of the present disclosure.

FIG. 12 illustrates an exemplary winding layout and a distribution of Ampere-Turns at β=60° in accordance with an exemplary embodiment of the present disclosure.

FIG. 13 illustrates an exemplary winding layout and a distribution of Ampere-Turns at β=120° in accordance with an exemplary embodiment of the present disclosure.

FIG. 14 illustrates an exemplary winding layout and a distribution of Ampere-Turns at β=180° in accordance with an exemplary embodiment of the present disclosure.

FIG. 15 illustrates an exemplary winding layout and a distribution of Ampere-Turns at β=240° in accordance with an exemplary embodiment of the present disclosure.

FIG. 16 illustrates an exemplary winding layout and a distribution of Ampere-Turns at β=300° in accordance with an exemplary embodiment of the present disclosure.

FIGS. 17A to 17AN illustrate a Sen Transformer arranged in a shunt-shunt configuration and having a winding arrangement according to an exemplary embodiment of the present disclosure.

FIGS. 18A to 18B illustrate a series-series transformer configuration according to an exemplary embodiment of the present disclosure.

FIG. 19 illustrates a Generalized Sen Transformer (GST) configured to generate both the shunt- and series-compensating voltages in a single unit in accordance with an exemplary embodiment of the present disclosure.

FIG. 20 illustrates a method of generating a compensating voltage in accordance with an exemplary embodiment of the present disclosure.

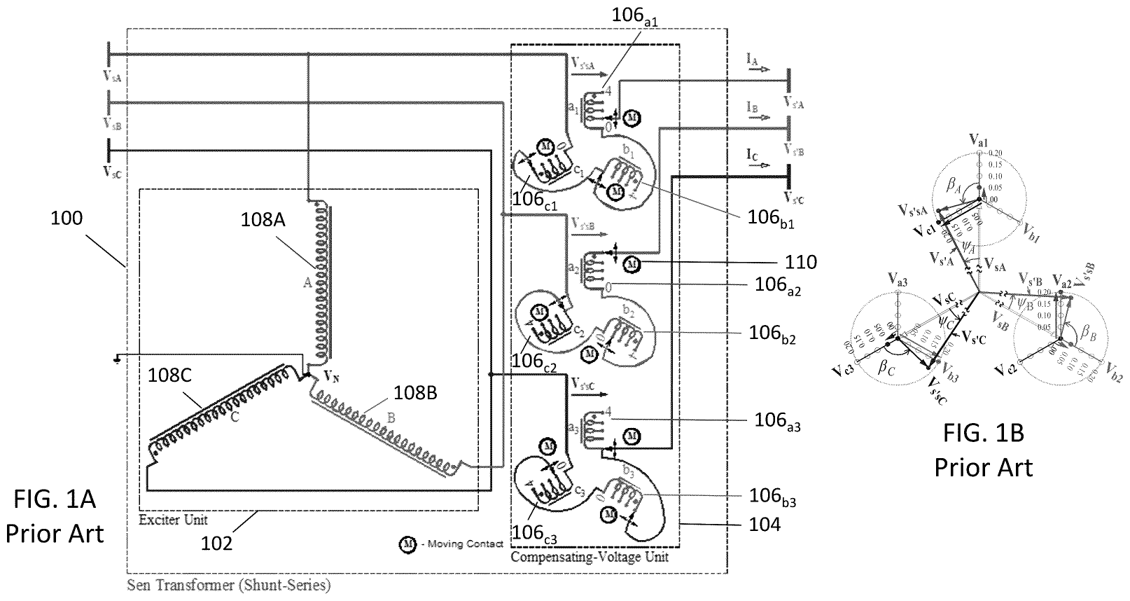

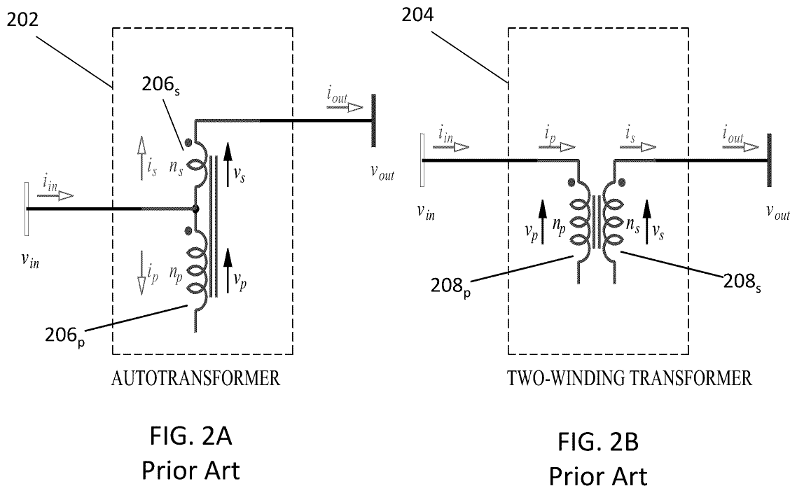

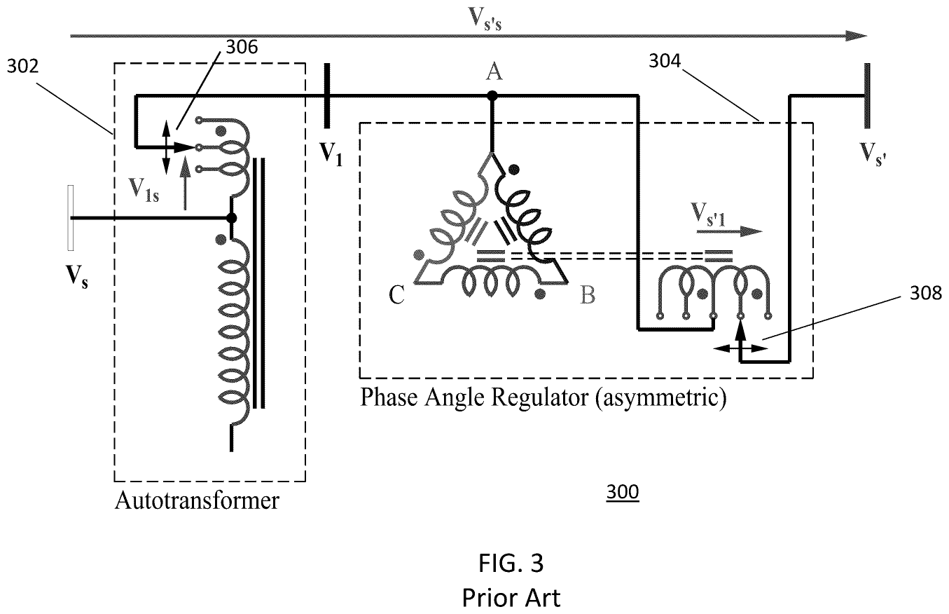

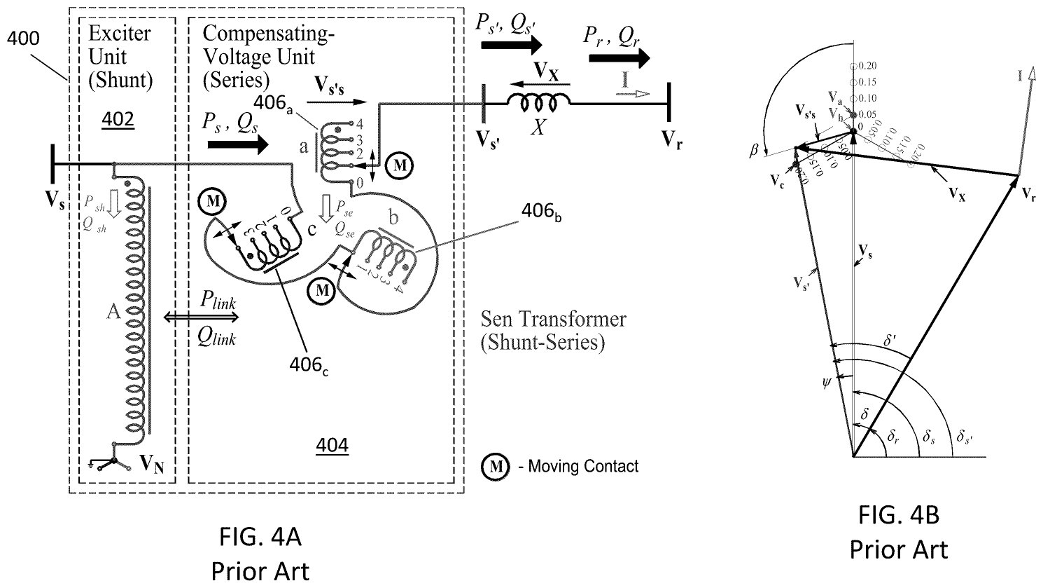

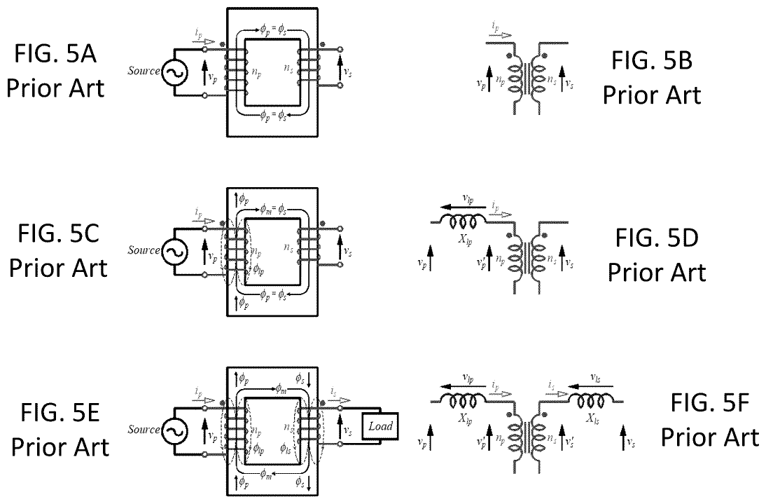

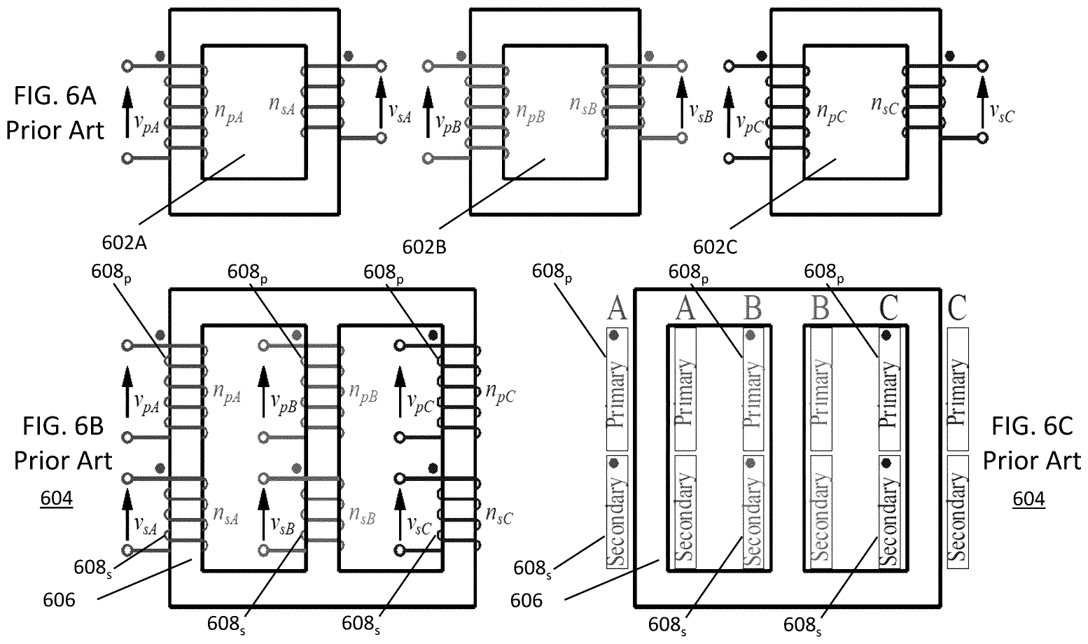

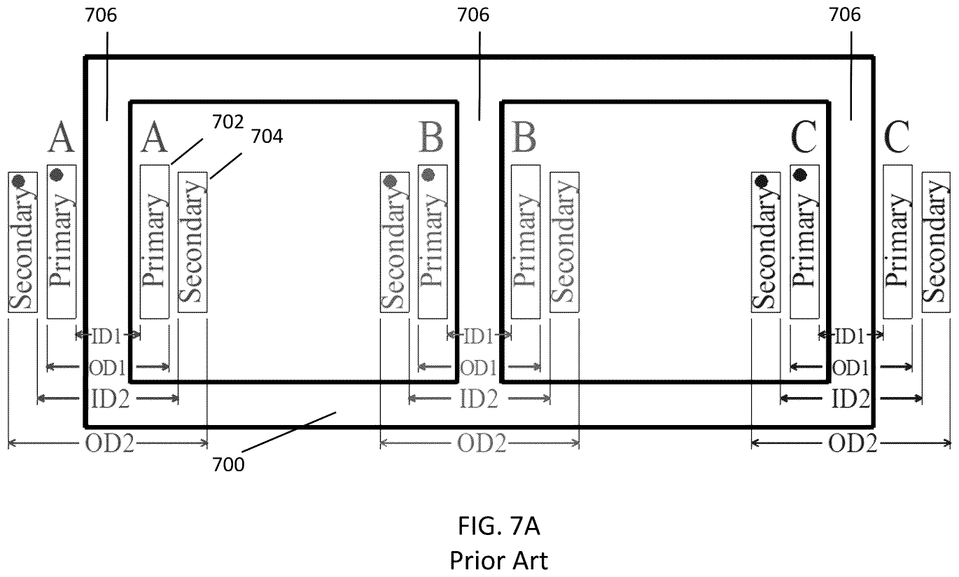

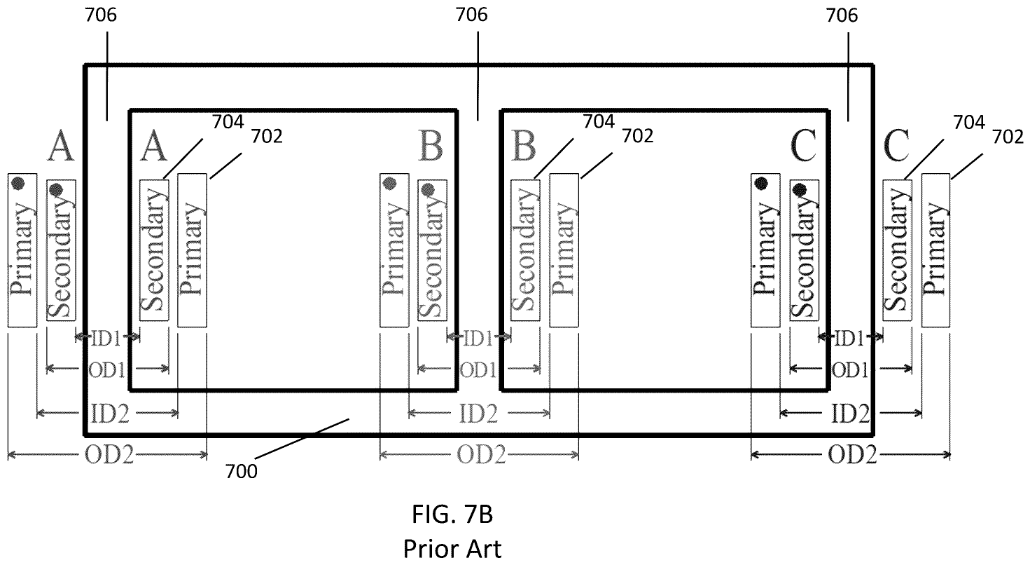

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

Exemplary embodiments of the present disclosure are directed to a Sen Transformer in which the compensating voltage is a phasor sum of three voltages, induced in the secondary windings, each from a different phase—A, B or C. The windings are strategically arranged about the legs of the transformer so that a balanced leakage impedance in each phase is realized. According to exemplary embodiments which will be described in further detail, all the primary windings have the same internal diameters (ID1) and outer diameters (OD1), and substantially similar heights; and all secondary windings and sub-windings between two consecutive taps associated with a group according to a specified load tap changer have the same internal diameters and outer diameters, and have substantially similar heights (i.e., lengths). The sub-windings may or may not be interleaved.

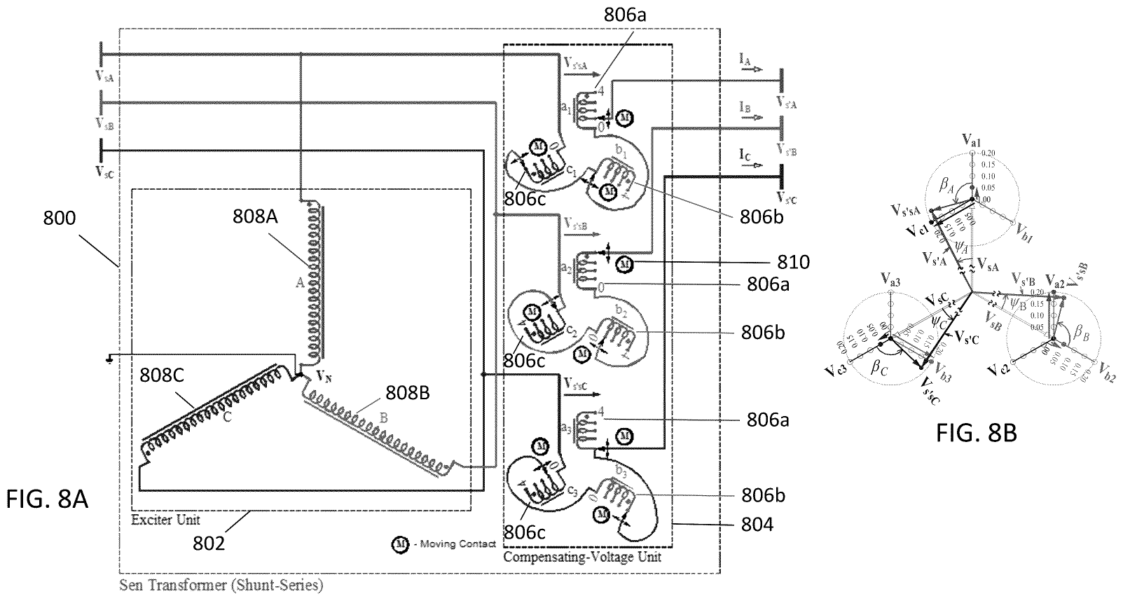

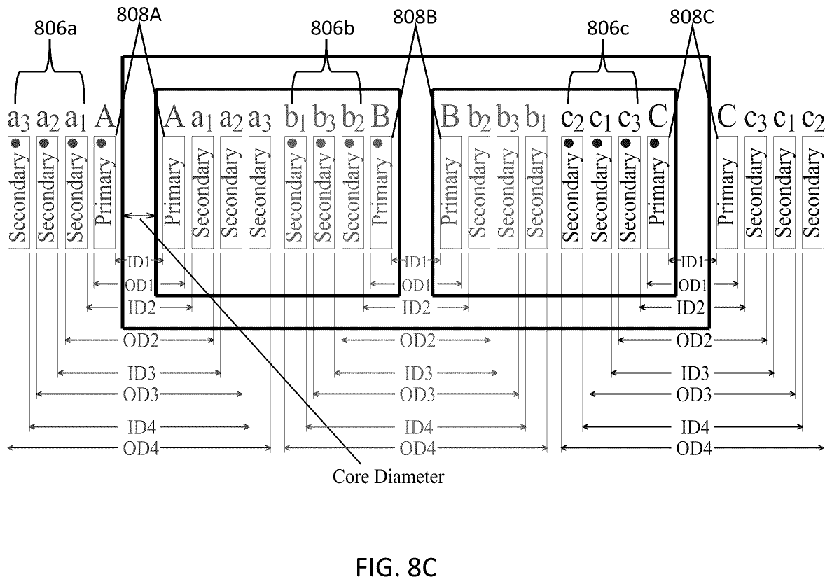

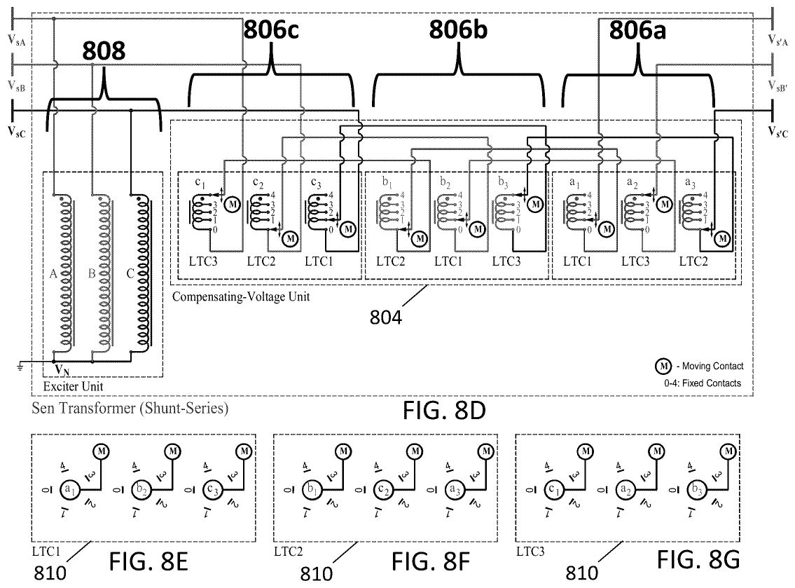

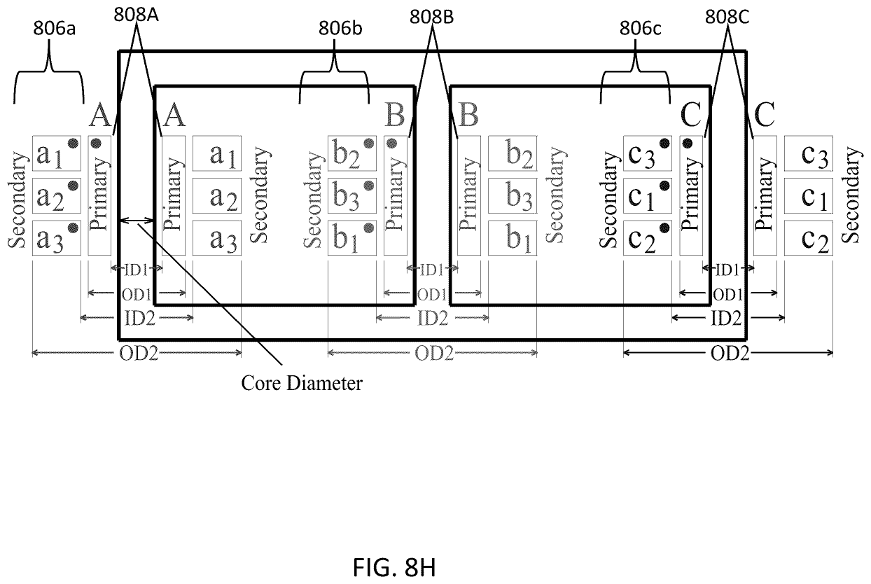

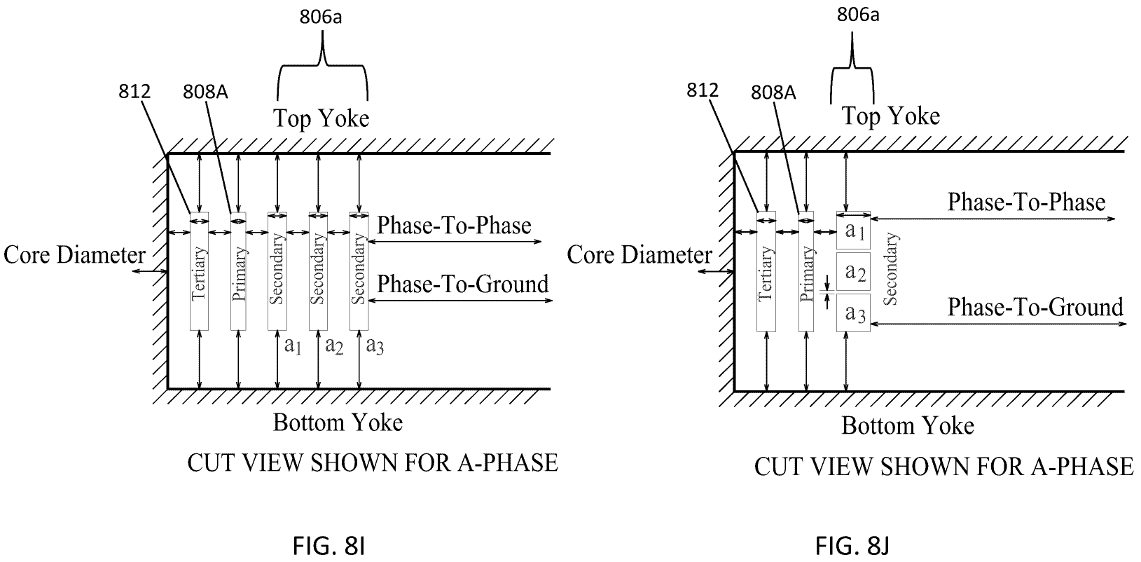

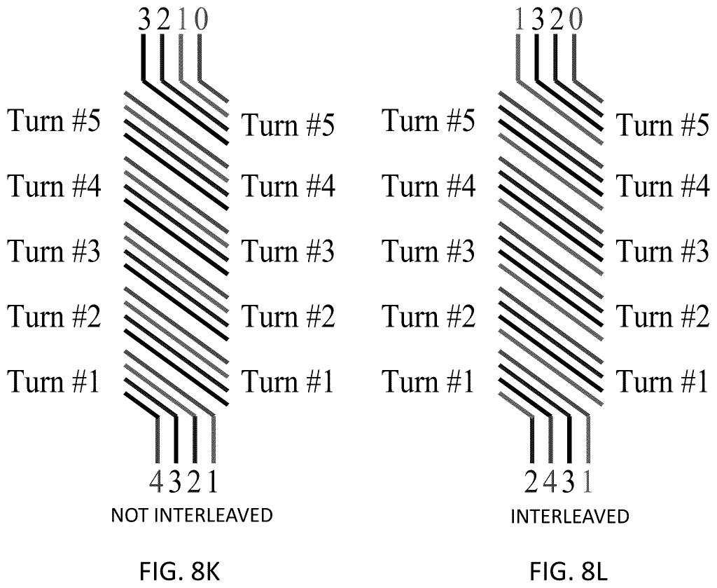

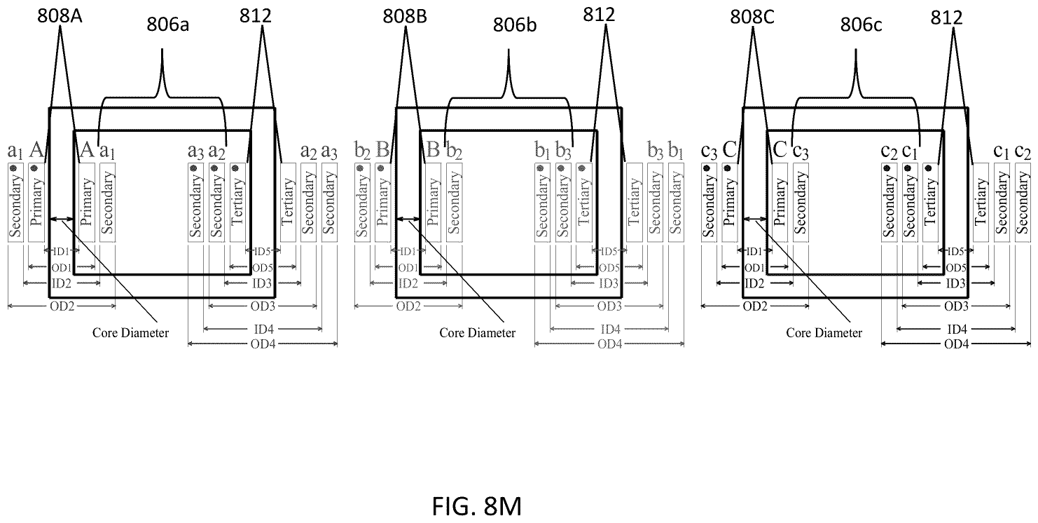

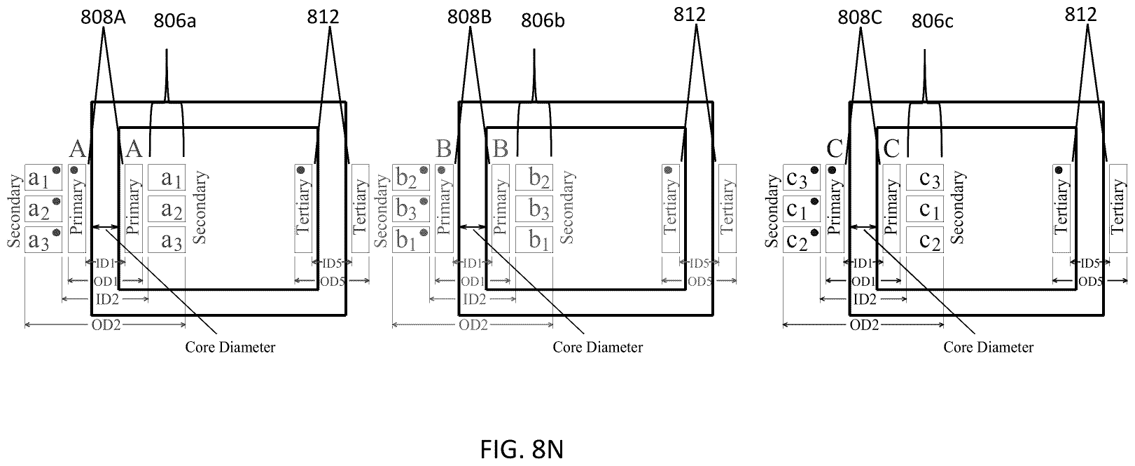

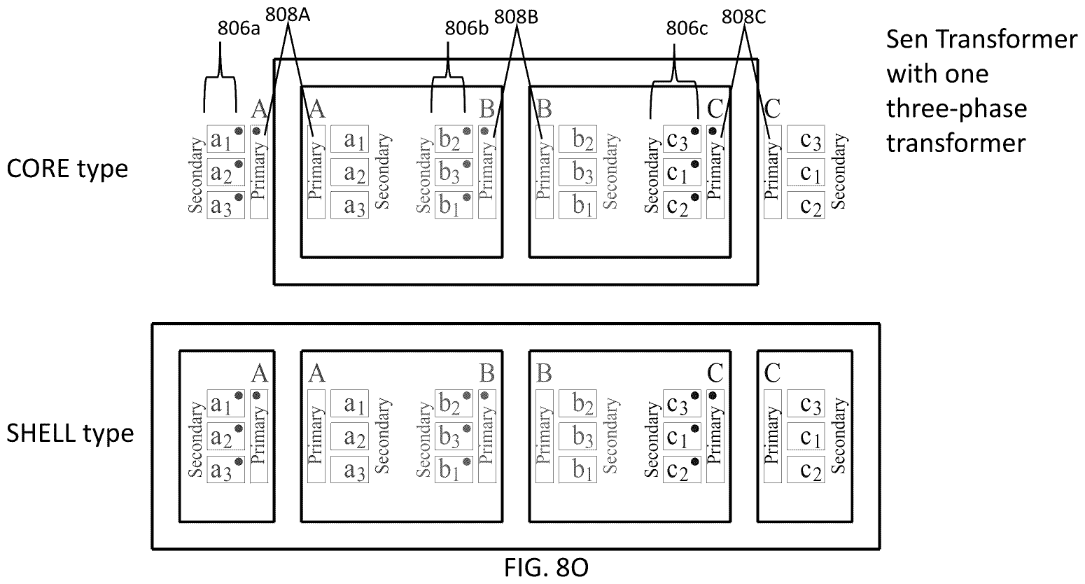

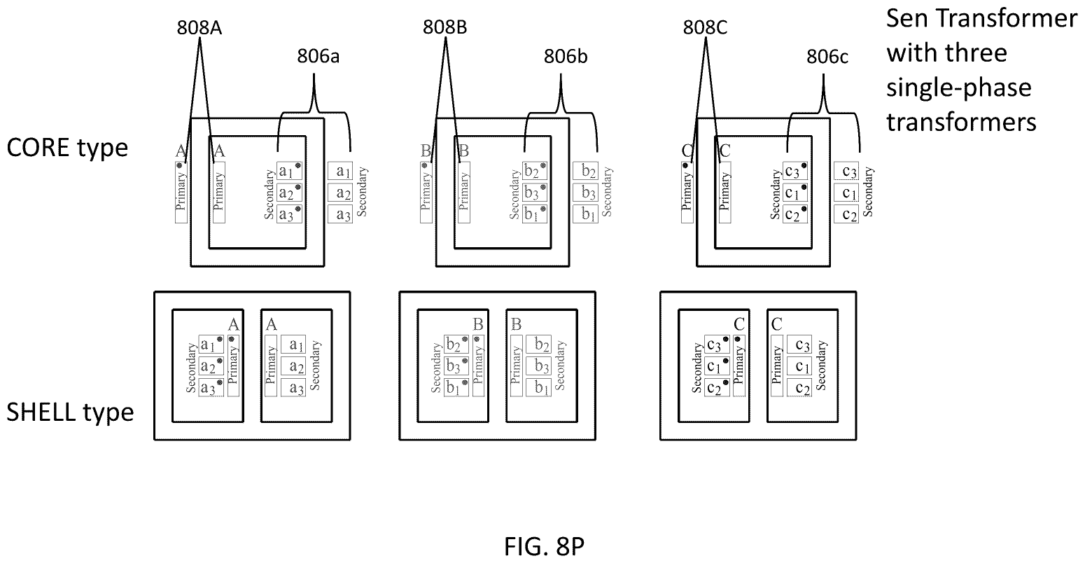

Exemplary embodiments of the present disclosure are based on the Sen Transformer 800 of FIG. 8A, which can be configured for controlling independent active and reactive power flows in a transmission line as described herein. The transformer 800 includes an Exciter Unit 802 and a Compensating-Voltage Unit 804. According to an exemplary embodiment, the Exciter Unit 802 includes a three-phase transformer with shunt Y-connected primary windings 808A, 808B, and 808C. The Compensating-Voltage Unit 804 includes plural series-connected secondary windings 806 in each phase of the Exciter Unit 802. The Compensating-Voltage Unit 804 also includes plural load tap changers 810, wherein each load tap changer 810 is associated with one of the plural secondary windings 806ₐ₁, 806ₐ₂, 806ₐ₃, 806_{b1}, 806_{b2}, 806_{b3}, 806_{c1}, 806_{c2}, and 806_{c3}. The secondary windings can be allocated to three groups of LTC control, where each group has one secondary winding from each phase (A, B, and C) of the Exciter Unit 802, and each secondary winding in a group is set to the same load setting. Each secondary winding 806ₐ₁, 806ₐ₂, 806ₐ₃, 806_{b1}, 806_{b2}, 806_{b3}, 806_{c1}, 806_{c2}, and 806_{c3} in a group of secondary windings associated with LTC1, LTC2, and LTC3 is located at a same distance from an associated primary winding 808A, 808B, and 808C of the Exciter Unit 802, and wherein each load tap changer is configured to vary an effective number of turns of the associated group LTC1, LTC2, and LTC3 of secondary windings by connecting to one of plural taps 810 associated with each secondary winding 806ₐ₁, 806ₐ₂, 806ₐ₃, 806_{b1}, 806_{b2}, 806_{b3}, 806_{c1}, 806_{c2}, and 806_{c3} according to a selected operating point.

FIGS. 8A to 8P illustrate exemplary winding arrangements for a Sen Transformer according to an exemplary embodiment of the present disclosure.

As shown in FIG. 8C, the three (3) exciter windings 808A, 808B, 808C may be the innermost windings. The winding placement of FIG. 8C can be configured such that all the primary windings have the same internal diameters (IDs) and outer diameters (ODs), and all the secondary windings have the same internal diameters IDs and outer diameters ODs. In addition, all the windings (i.e., the primary windings and the secondary windings) can have substantially the same height or length. Furthermore, the secondary windings can be placed on top of the primary windings in a sequence according to the LTC grouping. According to an exemplary embodiment, the nine (9) compensating windings 806ₐ₁, 806ₐ₂, 806ₐ₃, 806_{b1}, 806_{b2}, 806_{b3}, 806_{c1}, 806_{c2}, 806_{c3} (secondary windings) can be arranged as follows:
As shown in FIGS. 8C, 8D and 8E, secondary windings 806ₐ₁, 806_{b2}, and 806_{c3} that are connected to LTC1 have the same inner diameter (ID2) and outer diameter (OD2) and can be placed over the exciter windings 808A, 808B, and 808C, respectively.
As shown in FIGS. 8C, 8D and 8G, secondary windings 806ₐ₂, 806_{b3}, and 806_{c1} that are connected to LTC3 have the same internal diameter (ID3) and outer diameter (OD3) and can be placed over the secondary windings 806ₐ₁, 806_{b2}, and 806_{c3}, respectively.
As shown in FIGS. 8C, 8D and 8F, secondary windings 806ₐ₃, 806_{b1}, and 806_{c2} that are connected to LTC2 have the same internal diameter (OD4) and outer diameter (OD4) and can be placed over the secondary windings 806ₐ₂, 806_{b3}, and 806_{c1}, respectively.

According to an exemplary embodiment, the LTC windings can be concentric over each other, the exciter windings 808A, 808B, and 808C are fully rated. The three (3) sets of compensating windings (806a₁, 806b₂, and 806c₃), (806b₁, 806c₂, and 806a₃), and (806c₁, 806a₂, and 806b₃) are each rated at full power.

FIGS. 8A and 8B illustrate series compensating voltages generated, by a Sen Transformer 800, having the winding placement of FIG. 8A in accordance with an exemplary embodiment of the present disclosure. Based on the winding placement of FIG. 8A, the series-compensating voltage (V_{s′sA}) is constructed by taking three available induced voltages Vₐ₁, V_{b1}, and V_{c1} from the exciter phases that are 120° apart and adding them up. Similarly, the series-compensating voltage (V_{s′sB}) is constructed by taking three available induced voltages Vₐ₂, V_{b2}, and V_{c2} from the exciter phases that are 120° apart and computing the sum; and the series-compensating voltage (V_{s′sC}) is constructed by summing the three available induced voltages Vₐ₃, V_{b3}, and V_{c3} from the exciter phases that are 120° apart. With the use of LTCs (LTC1, LTC2, and LTC3), the effective number of turns in each secondary (i.e., compensating) winding in the three (3) sets of secondary (i.e., compensating) windings (806ₐ₁, 806_{b2}, and 806_{c3}), (806_{b1}, 806_{c2}, and 806ₐ₃), and (806_{c1}, 806ₐ₂, and 806_{b3}), respectively, in each phase is varied, and the composite voltage becomes variable in magnitude and phase angle.

The magnitude of the induced voltage (V) in one or more of the secondary windings 806a₁, 806a₂, 806a₃, 806b₁, 806b₂, 806b₃, 806c₁, 806c₂, and 806c₃ that are active, the voltage (x) across each tap of LTC1, LTC2, and LTC3, and the number (N) of taps in the LTC are related by the following equation:

$$N = \frac{V}{x} . \qquad ( 15 )$$

According to an exemplary embodiment of the present disclosure, the sending-end voltage, Vₛ=1, the allowable magnitude (V) of the induced voltage (V) can be set to 0.2 and the voltage (x) across each tap of an LTC can be 0.05. Therefore, the Sen Transformer 800 has N=0.2/0.05 or N=4 taps in each secondary winding 806ₐ₁, 806ₐ₂, 806ₐ₃, 806_{b1}, 806_{b2}, 806_{b3}, 806_{c1}, 806_{c2}, and 806_{c3}. Therefore, according to the exemplary configuration of the Sen Transformer 800, each of the secondary windings 806ₐ₁, 806ₐ₂, 806ₐ₃, 806_{b1}, 806_{b2}, 806_{b3}, 806_{c1}, 806_{c2}, and 806_{c3} may be tapped at one of tap positions 0, 1, 2, 3 or 4. The selected tap position determines the percentage, for example, 0%, 5%, 10%, 15%, and 20%, respectively, of the primary, i.e., exciting voltage by which each of the secondary windings 806ₐ₁, 806ₐ₂, 806ₐ₃, 806_{b1}, 806_{b2}, 806_{b3}, 806_{c1}, 806_{c2}, and 806_{c3} is active. The selected tap position also determines how much the associated secondary windings 806ₐ₁, 806ₐ₂, 806ₐ₃, 806_{b1}, 806_{b2}, 806_{b3}, 806_{c1}, 806_{c2}, and 806_{c3} contribute toward forming the compensating voltage. For example, for tap positions 0, 1, 2, 3, or 4, the secondary winding's contribution to the compensating voltage can be 0.0 (0%), 0.05 (5%), 0.10 (10%), 0.15 (15%), or 0.20 (20%), respectively.

The tap positions for load tap changers LTC1, LTC2, and LTC3 for an arbitrary operating point of the Sen Transformer 800 are shown in FIGS. 8E through 8G. For example, the secondary windings associated with the first phase of the Exciter Unit 802, the compensating winding 806a₁, is tapped for 0.05 pu voltage, the compensating-winding 806b₁ is tapped for 0.0 pu voltage, and the compensating winding 806c₁ is tapped for 0.20 pu voltage.

According to exemplary embodiments of the present disclosure, moving the contacts of the LTCs to a higher tap position (e.g., 0→1, 1→2, 2→3, 3→4, etc.,) (i.e., toward the dot) increases the series-compensating voltage, V_{s′s}. The primary 808A, 808B, and 808C and secondary windings 806ₐ₁, 806ₐ₂, 806ₐ₃, 806_{b1}, 806_{b2}, 806_{b3}, 806_{c1}, 806_{c2}, and 806_{c3} are considered to have 1 pu and 0.20 pu voltage ratings, respectively. According to exemplary embodiments described herein, each of the secondary windings 806ₐ₁, 806ₐ₂, 806ₐ₃, 806_{b1}, 806_{b2}, 806_{b3}, 806_{c1}, 806_{c2}, and 806_{c3} can have an LTC contact located at every 5% tap position and includes five taps, marked 0 through 4. At tap position 0, each secondary winding is bypassed.

FIG. 8H illustrates an exemplary winding arrangement in which multiple secondary windings for each primary winding are placed having the same inner diameter (ID2) as well as the outer diameter (OD2). For example, for a phase A of the Sen Transformer 800, the primary winding 808A is placed as the inner winding on the core leg, and the secondary windings 806ₐ₁, 806ₐ₂, and 806ₐ₃ form plural rings around the primary winding 808A. Each of the secondary windings is having the same inner diameter (ID2) and outer diameter (OD2). Similarly, for the phase B, the primary winding 808B is the inner winding on the corresponding core leg, and the secondary windings 806_{b1}, 806_{b2}, and 806_{b3} are the outer windings that form plural rings around the primary winding 808B; and for the phase C, the primary winding 808C is the inner winding on the corresponding core leg, and the secondary windings 806_{c1}, 806_{c2}, and 806_{c3} are the outer windings that form plural rings around the primary winding 808C. Just as with phase A, the secondary windings for the B and C phases of the Sen Transformer 800 are having the same ID and OD.

FIGS. 81 and 8J illustrate winding arrangements for the Sen Transformer of FIG. 8A, that include a tertiary winding in accordance with an exemplary embodiment of the present disclosure. As shown in FIG. 8I, the winding arrangement can include plural nested and concentric windings such that for phase A, the tertiary winding 812 is the innermost winding and placed closest to the core leg, and the three secondary windings 806ₐ₁, 806ₐ₂, and 806ₐ₃ are the outer windings where secondary winding 806ₐ₃ is the outermost winding. The primary winding 808A is placed as the middle winding between the tertiary winding 812 and inner secondary winding 806ₐ₁. The winding arrangement of FIG. 8J is similar to the arrangement shown in FIG. 8H with the addition of tertiary winding 812. As shown in FIG. 8J, the tertiary winding 812 is the innermost winding and the set of secondary windings 806ₐ₁, 806ₐ₂, and 806ₐ₃ are the outermost windings. The primary winding 808A is arranged as the middle winding between the tertiary winding 812 and the set of secondary windings 806ₐ₁, 806ₐ₂, and 806ₐ₃. The set of secondary windings 806ₐ₁, 806ₐ₂, and 806ₐ₃ form plural rings around the primary winding 808A. While the tertiary winding 812 is only shown in relation to phase A, it should be understood that the arrangements shown in FIGS. 81 and 8J are equally applicable and available for phases B and C of the Sen Transformer 800. According to the exemplary embodiments of FIGS. 81 and 8J, the tertiary winding 812 is delta-connected, meaning it is a delta winding whose only one terminal comes out of the transformer for grounding purpose. In addition, the tertiary winding 812 does not supply power to any load and is always closed. The tertiary winding remains in a closed state and serves as a safety measure under conditions when the LTCs switch taps on the secondary windings 806ₐ₁, 806ₐ₂, 806ₐ₃, 806_{b1}, 806_{b2}, 806_{b3}, 806_{c1}, 806_{c2}, and 806_{c3}, which can be in an open state during the switching transition from one tap position to the next. This condition results in an unbalanced current flow through the secondary windings, which is not desirable. The tertiary winding 812 has a zero-sequence impedance that will produce a zero-sequence voltage drop when the zero-sequence current flows through the tertiary winding. The tertiary winding 812 is a stabilizing winding which acts as a “bridge” when switching transition from one tap position to the next occurs.

FIG. 8K illustrates a non-interleaved arrangement of any one of the nine secondary windings (806ₐ₁, 806ₐ₂, 806ₐ₃, 806_{b1}, 806_{b2}, 806_{b3}, 806_{c1}, 806_{c2}, and 806_{c3}) in a Sen Transformer in accordance with an exemplary embodiment of the present disclosure. The sub windings between any two tap positions of each secondary winding can be placed in a non-interleaved arrangement. For example, the taps of each winding are associated with a sequential arrangement of the taps sequence (i.e., 0 to 3 and 4 to 1).

FIG. 8L illustrates an interleaved arrangement of any one of the nine secondary windings (806ₐ₁, 806ₐ₂, 806ₐ₃, 806_{b1}, 806_{b2}, 806_{b3}, 806_{c1}, 806_{c2}, and 806_{c3}) in a Sen Transformer in accordance with an exemplary embodiment of the present disclosure. The sub windings between any two tap positions of each secondary winding can be placed in an interleaved arrangement. For example, the taps of each winding are associated with a non-sequential arrangement of the taps sequence (i.e., 0, 2, 3, 1 and 2, 4, 3, 1).

FIG. 8M illustrates a winding arrangement for a set of three single-phase Sen Transformers with a tertiary winding in accordance with an exemplary embodiment of the present disclosure. As shown in FIG. 8M, the windings can be arranged such that for each single-phase transformer the primary winding 808A, 808B, or 808C is the innermost winding (closest to the core) on one limb with ID1 and OD1 and the tertiary winding 812 with ID5 and OD5 is also located closest to the core on another limb. For the single-phase transformer with A-phase-excited voltage, the secondary winding 806ₐ₁ can be placed over the exciter winding 808A (closest to the core) on one limb such that the windings are concentric. In addition, secondary windings 806ₐ₂ and 806ₐ₃ can be placed over the tertiary winding 812 on another limb where the secondary winding 806ₐ₃ is the outermost winding and the three windings 812, 806ₐ₂, and 806ₐ₃ are concentric on the same limb. For the single-phase transformer with B-phase-excited voltage, the secondary winding 806_{b2} can be placed over the exciter winding 808B (closest to the core) on one limb such that the windings are concentric. In addition, secondary windings 806_{b3} and 806_{b1} can be placed over the tertiary winding 812 on another limb where the secondary winding 806_{b1} is the outermost winding and the three windings 812, 806_{b3}, and 806_{b1} are concentric on the same limb. Similarly, for the single-phase transformer with C-phase-excited voltage, the secondary winding 806_{c3} can be placed over the exciter winding 808C (closest to the core) on one limb such that the windings are concentric. In addition, secondary windings 806_{c1} and 806_{c2} can be placed over the tertiary winding 812 on another limb where the secondary winding 806_{c2} is the outermost winding and the three windings 812, 806_{c1}, and 806_{c2} are concentric on the same limb. The secondary windings that are connected to the same LTC have the same inner diameter (ID) and outer diameter (OD). For example, based on the winding placement shown in FIG. 8M, secondary windings 806ₐ₁, 806_{b2}, and 806_{c3} with ID2 and OD2 can be connected to LTC1, secondary windings 806ₐ₂, 806_{b3}, and 806_{c1} with ID3 and OD3 can be connected to LTC3, and secondary windings 806ₐ₃, 806_{b1}, and 806_{c2} with ID4 and OD4 can be connected to LTC2.

FIG. 8N illustrates a winding arrangement for a set of three single-phase Sen Transformers with a tertiary winding in accordance with an exemplary embodiment of the present disclosure. As shown in FIG. 8N, the windings can be arranged such that for each single-phase transformer the primary winding 808A, 808B, or 808C is the innermost winding (closest to the core) on one limb with ID1 and OD1 and the tertiary winding 812 with ID5 and OD5 is also located closest to the core on another limb. For the single-phase transformer with A-phase-excited voltage, the secondary windings 806ₐ₁, 806ₐ₂, and 806ₐ₃ form plural rings around the primary winding 808A. Each of the secondary windings is having the same inner diameter (ID2) and outer diameter (OD2). For the single-phase transformer with B-phase-excited voltage, the secondary windings 806_{b2}, 806_{b3}, and 806_{b1} form plural rings around the primary winding 808B. Each of the secondary windings is having the same inner diameter (ID2) and outer diameter (OD2). Similarly, for the single-phase transformer with C-phase-excited voltage, the secondary windings 806_{c3}, 806_{c1}, and 806_{c2} form plural rings around the primary winding 808C. Each of the secondary windings is having the same inner diameter (ID2) and outer diameter (OD2).

The exemplary embodiments of FIGS. 8A-8N disclose a core type transformer structure in which the transformer windings are wrapped around the core. It should be understood that the exemplary embodiments of the present disclosure are applicable and can be implemented in a shell-type transformer structure in which the core wraps around the transformer windings. FIGS. 8O and 8P illustrate winding arrangements of a core type transformer as compared to a shell type transformer according to exemplary embodiments of the present disclosure. As shown in FIGS. 8O and 8P, the primary windings 808A, 808B, and 808C and the secondary windings 806a, 806b, and 806c of the shell-type transformer are enclosed within the transformer core by an outer limb.

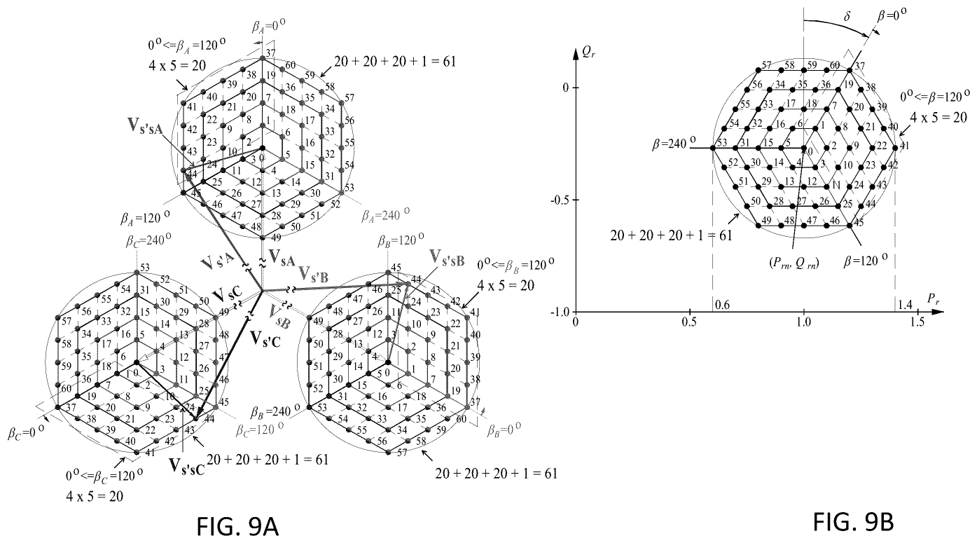

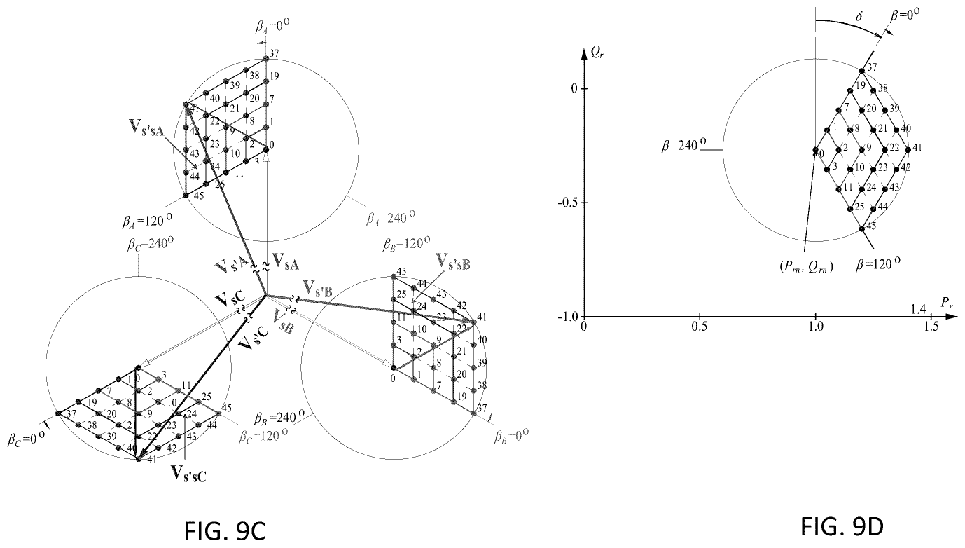

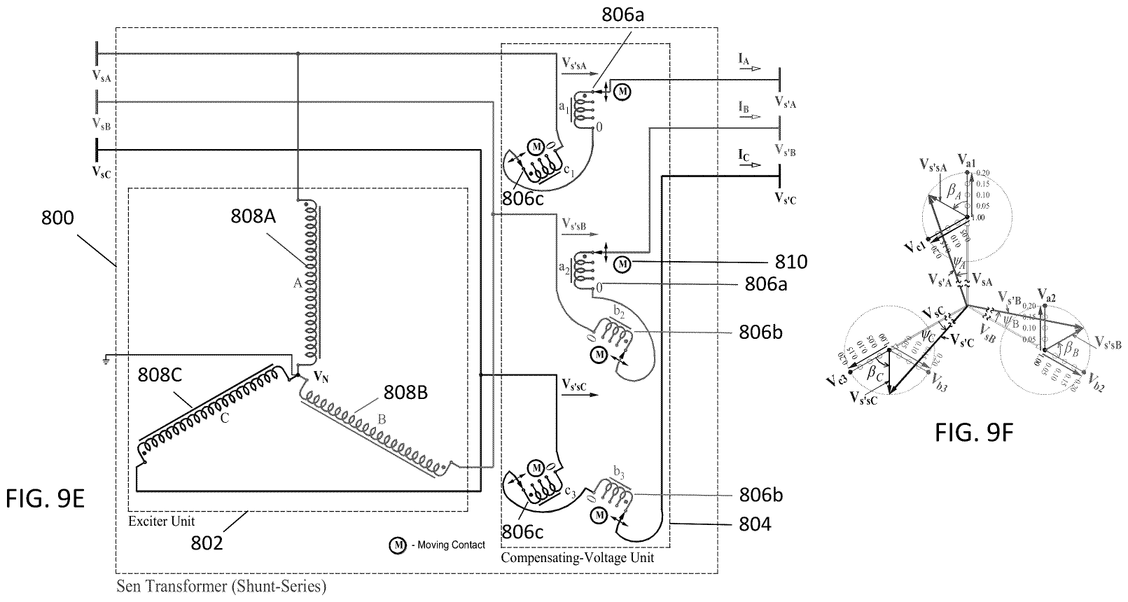

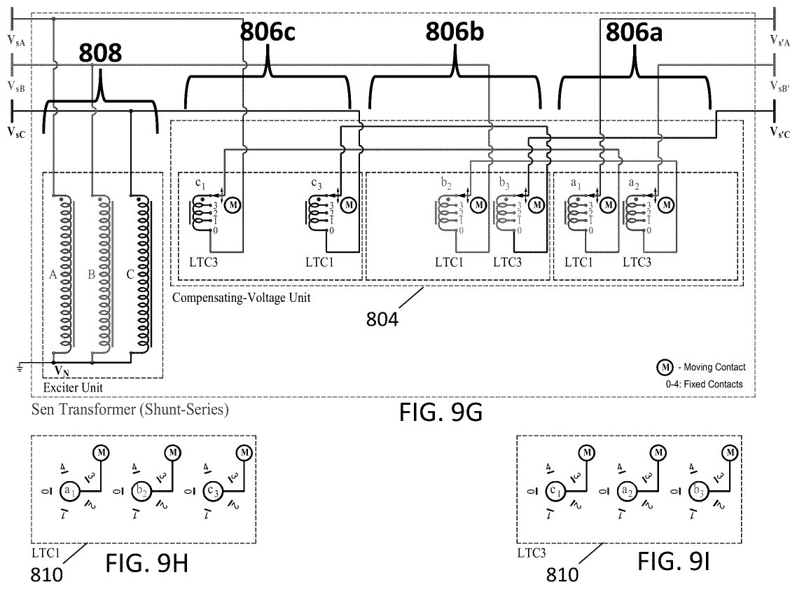

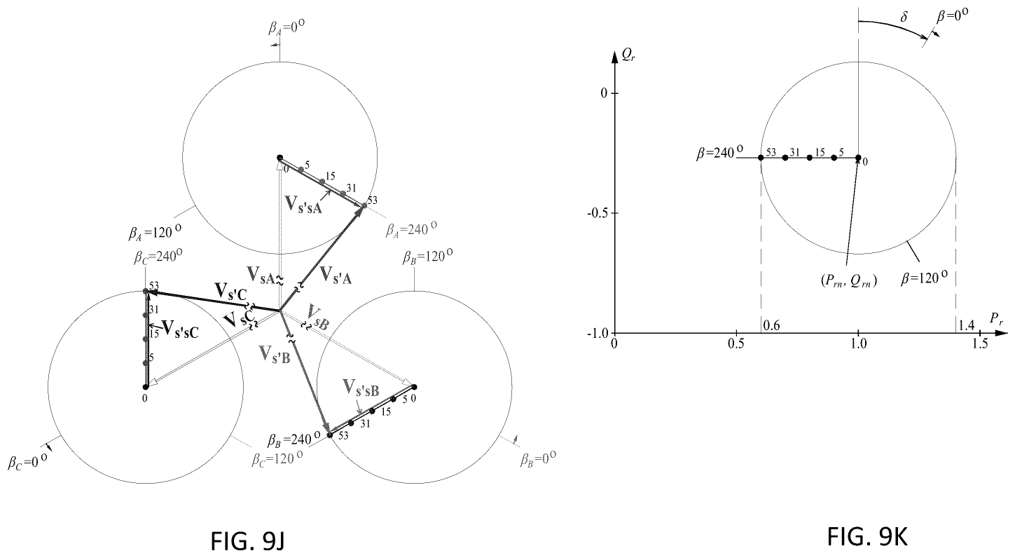

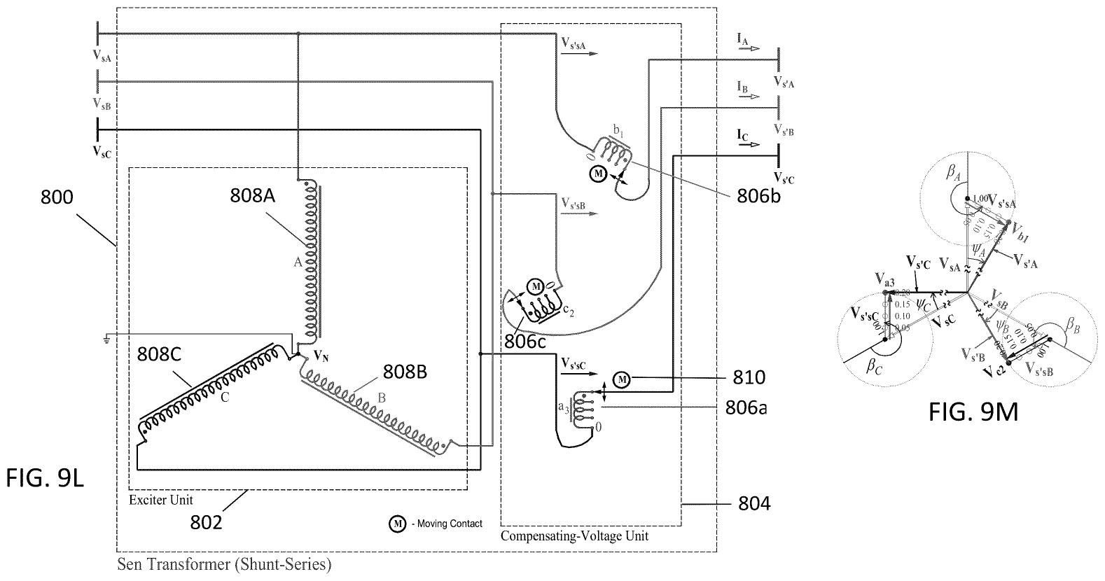

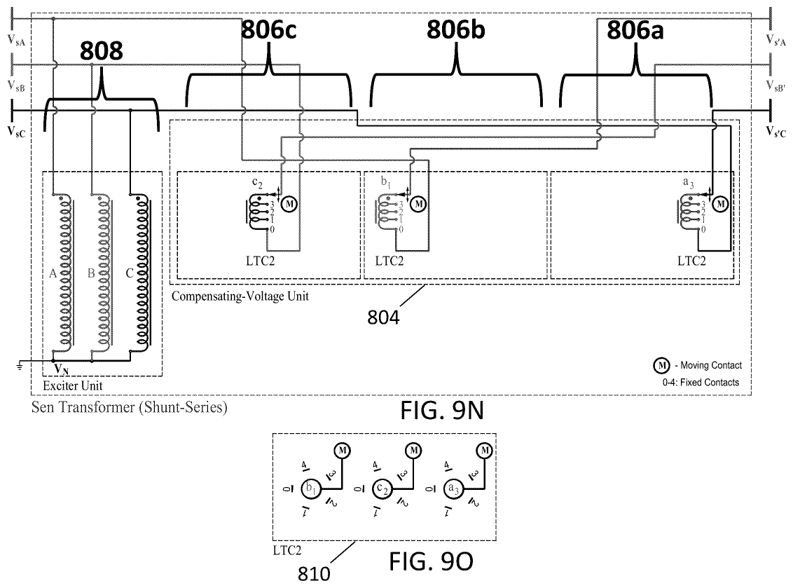

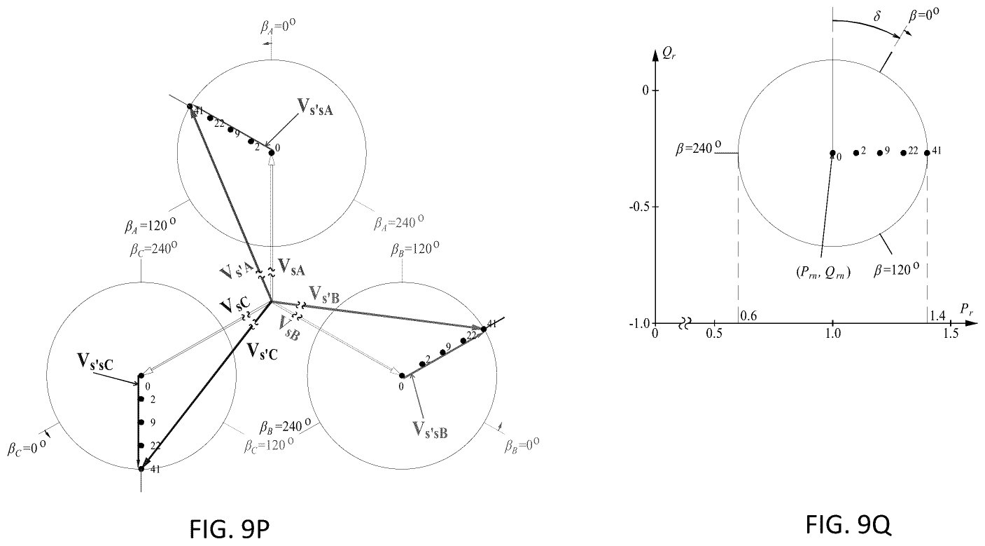

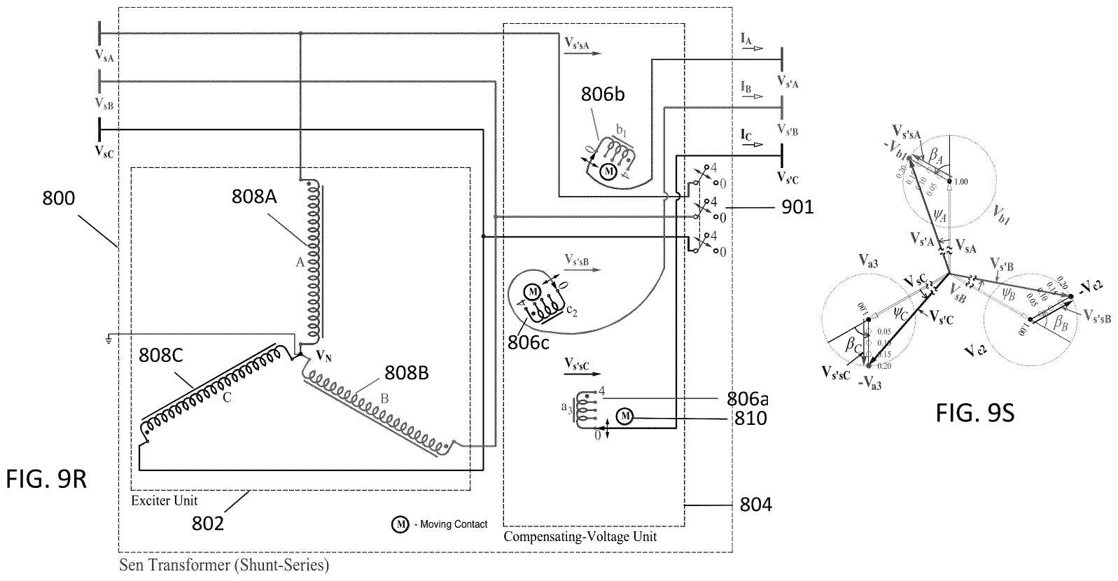

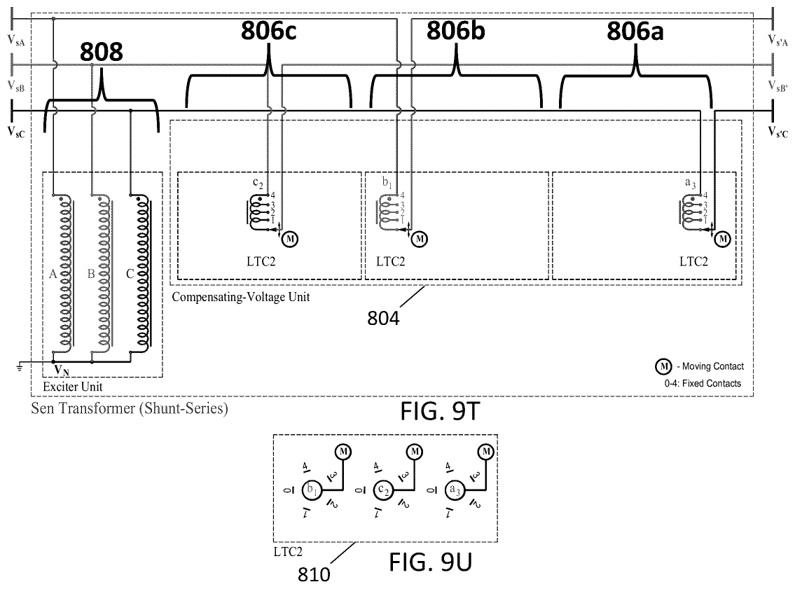

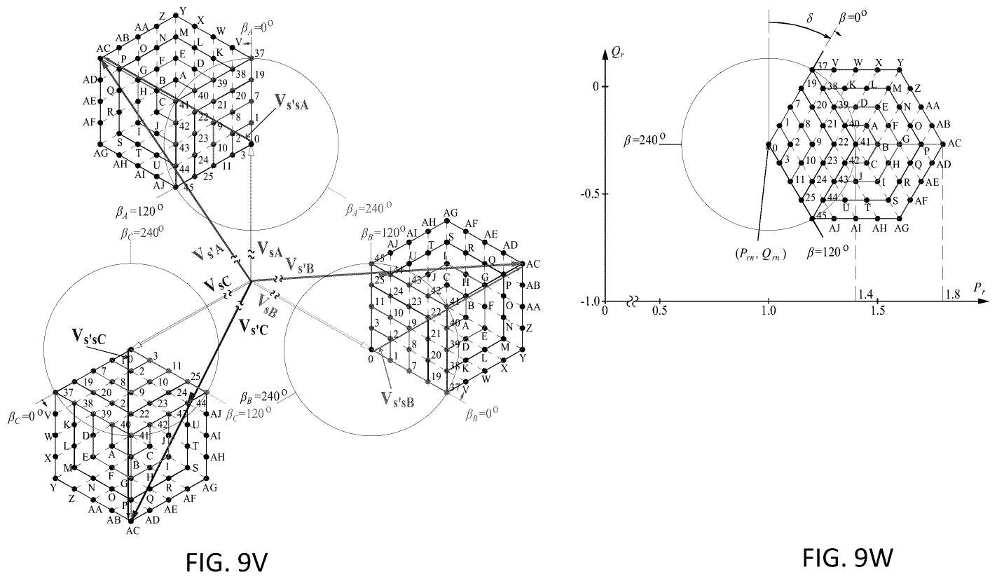

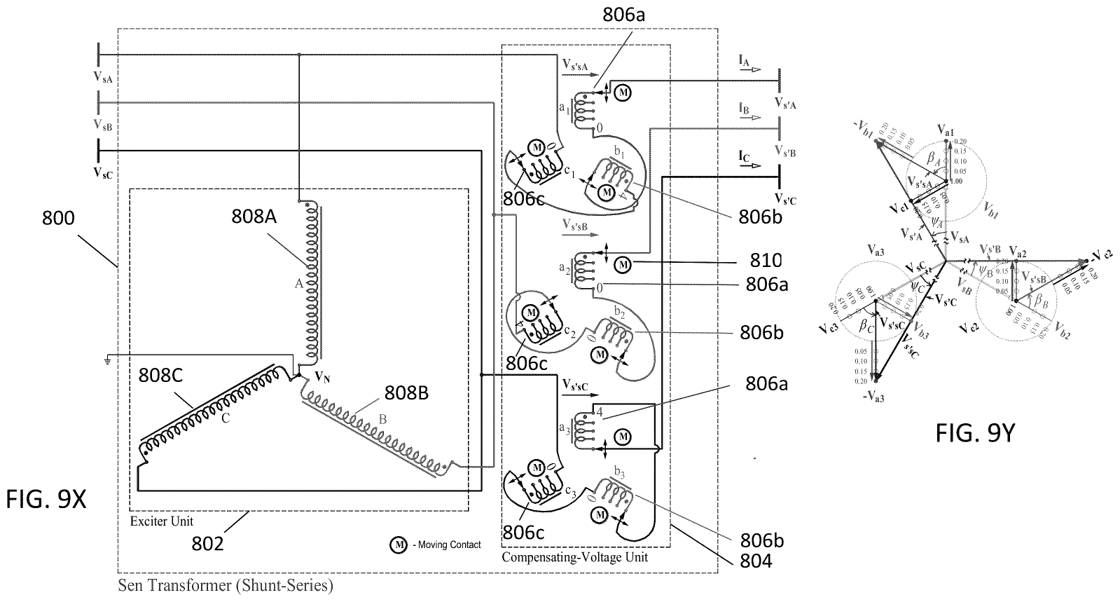

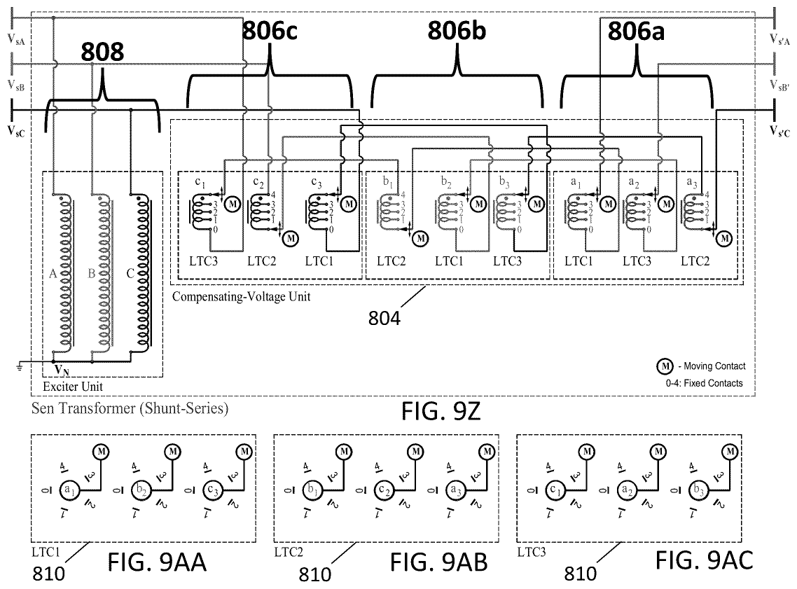

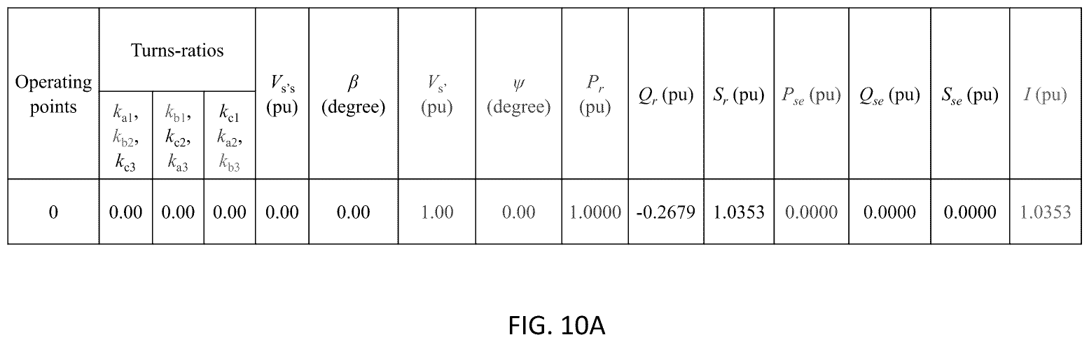

FIG. 9A shows the theoretically possible compensating points of the modified sending-end voltage with the use of the Sen Transformer 800. FIG. 9B shows the corresponding active and reactive power flows at the receiving end within the entire range of the relative phase angle of 0°≤β≤360°. FIG. 9B also shows that the maximum active power flow enhancement at the receiving end is 0.40 pu (from 1 pu to 1.4 pu) in this particular example. FIG. 9A shows that the theoretical circular control area with 0.20 pu fixed compensating voltage is a hexagon when a Sen Transformer is used. A larger number of taps in the LTCs make the compensating points closer to each other and vice versa.

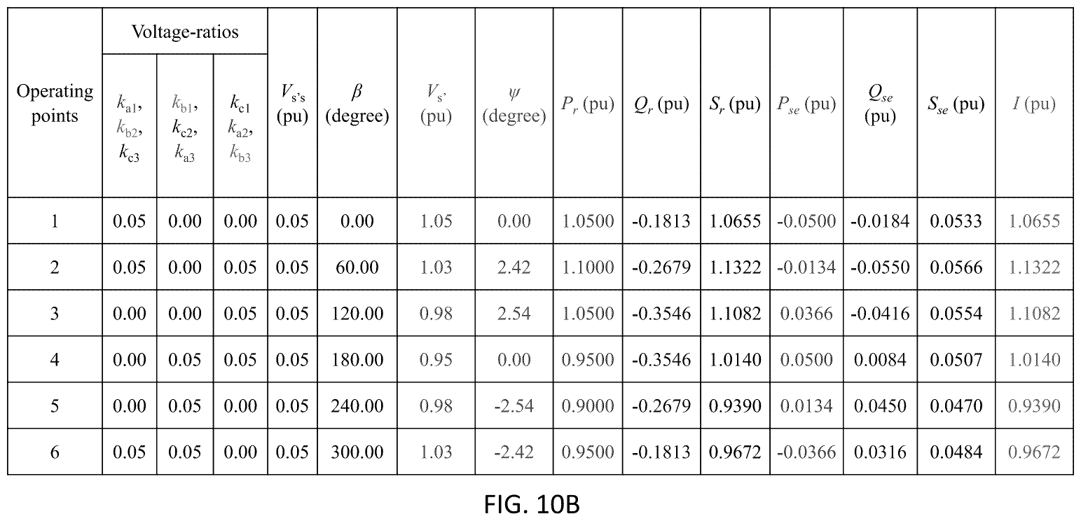

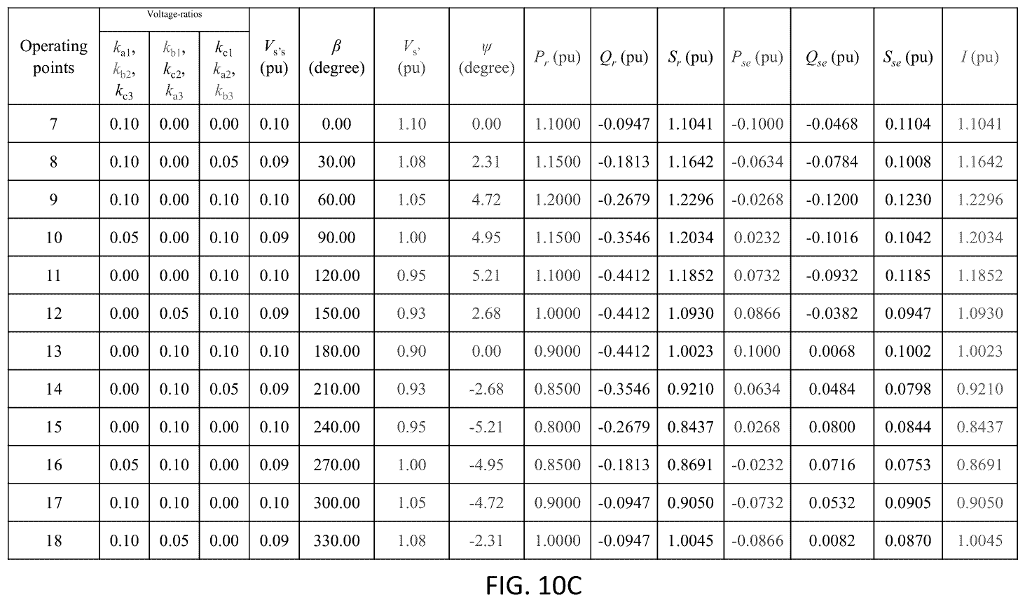

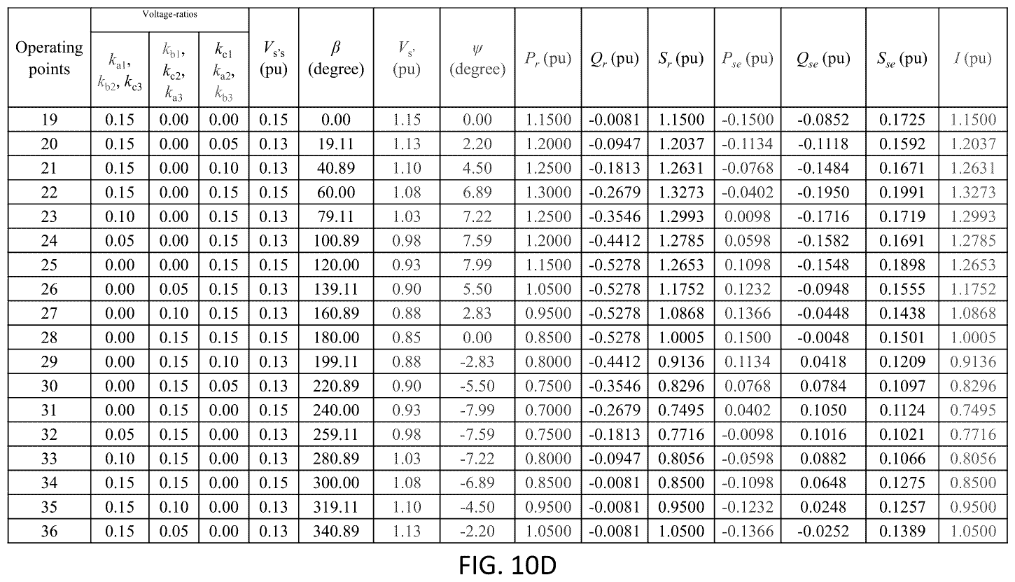

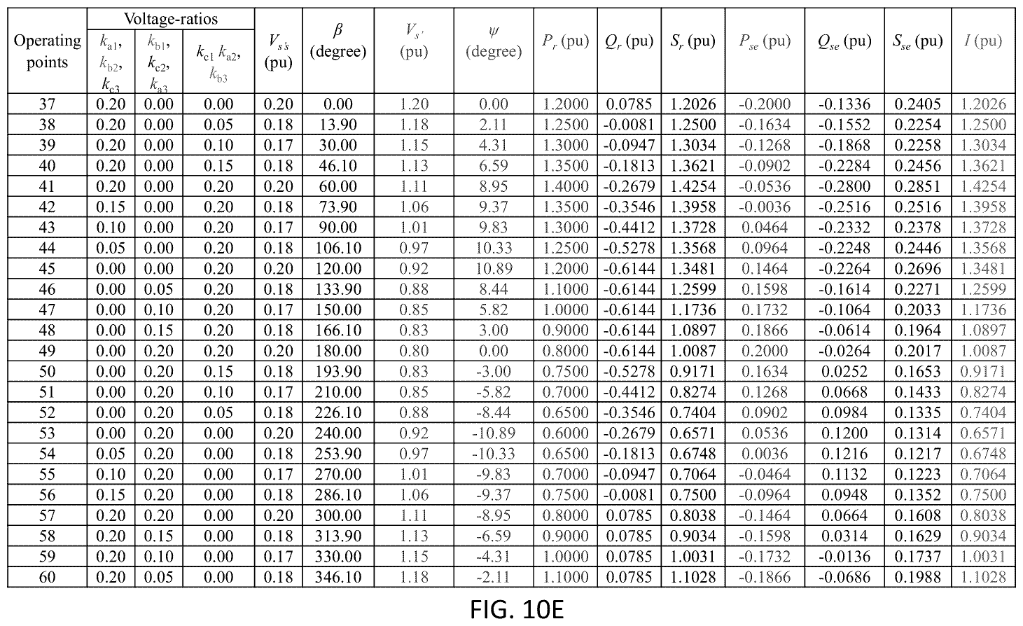

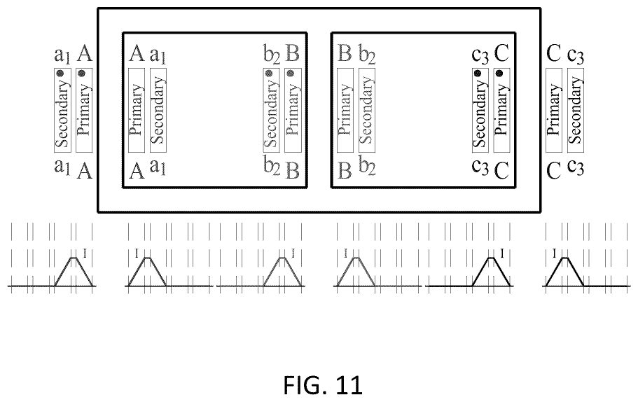

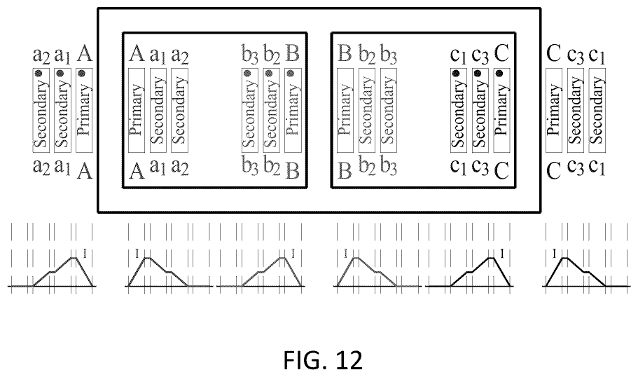

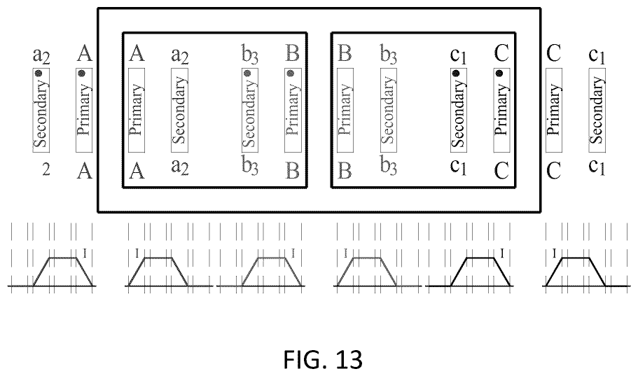

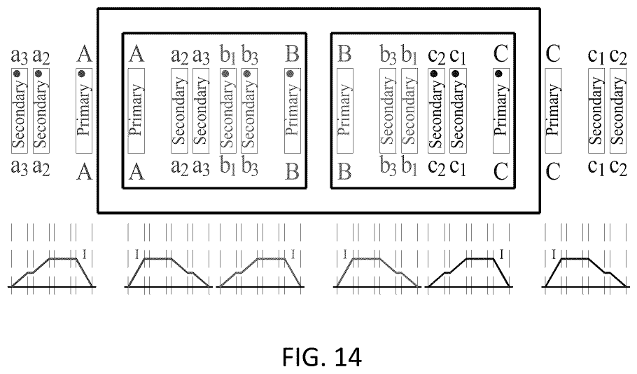

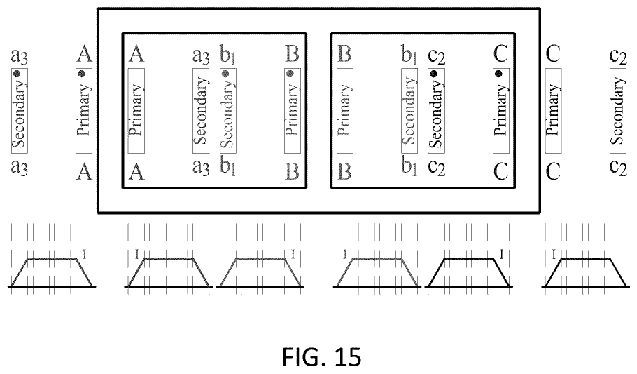

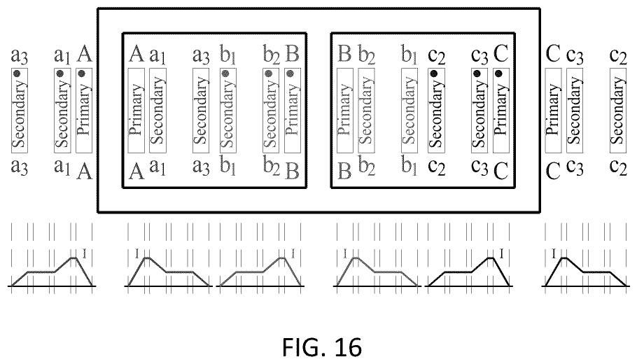

FIG. 9A also shows the locations of the tip of modified sending-end voltage phasor, V_{s′}. FIG. 9B shows the active and reactive power flows (Pᵣ and Qᵣ) operating points in accordance with an exemplary embodiment of the present disclosure. Each modified sending-end voltage operating point shown in FIG. 9A corresponds to a power flow operating point in the P-Q plane, shown in FIG. 9B. A subset of operating points (1, 7, 19, 37, 4, 13, 28, and 49) represent the operating points of a Voltage Regulator (VR). While the VR operating points lie on a straight line that is related to a relative phase angle, β=0° and β=180°, the Sen Transformer 800 operating points lie in a two-dimensional operating plane. In an actual application, for a desired active and reactive power flows (Pᵣ and Qᵣ) requirement from 61 possible operating points, the corresponding modified sending-end voltage (V_{s′}) phasor tip can be mapped in FIG. 9A and the proper tap position of the LTCs can be selected from the Tables shown in FIGS. 10A to 10E.

FIGS. 9C and 9D illustrate modified sending-end voltages operating points and the respective active and reactive power flows (Pᵣ and Qᵣ) operating points for a limited relative phase angle operation in the range of β=0° to β=120°. A relative phase angle operation at β=60° offers the maximum active power flow operating points.

FIGS. 9E and 9G illustrate the Sen Transformer of FIG. 8A being configured for a limited relative phase angle operation in the range of β=0° to β=120°, according to an exemplary embodiment of the present disclosure for the voltage operating points as shown in FIG. 9F. As shown in FIG. 9E, because the Sen Transformer 800 is configured to operate in a limited relative phase angle range of β=0° to β=120°, the compensating voltage unit 804 can be modified by removing the secondary windings associated with the phases outside of the relative phase angle range of interest. For example, for the compensating voltage unit 804 of FIG. 9E, the secondary windings 806b₁, 806c₂, and 806a₃ are made inactive during operation or can be omitted or removed from the transformer configuration. Omission or removal of the secondary windings from the transformer or making them inactive during operation can result in more thermal efficient operation of the Sen Transformer 800. Furthermore, omission and/or removal can lead to a reduction in size and cost of the transformer. The tap positions for load tap changers LTC1 and LTC3 for the maximum active power flow operating point (1.4 pu in this particular example) of the Sen Transformer 800 are shown in FIGS. 9H and 91. Only two tap changers are required for operation since one secondary winding corresponding to phases outside of the limited range of phase angles is made inactive during operation or is omitted or removed from the transformer configuration as already discussed.

FIGS. 9J and 9K illustrate modified sending-end voltages operating points and the respective active and reactive power flows (Pᵣ and Qᵣ) operating points for a limited relative phase angle operation at β=2400, which offers the minimum active power flow operating points.

FIGS. 9L and 9N illustrate the Sen Transformer of FIG. 8A for a limited relative phase angle operation at β=240° according to an exemplary embodiment of the present disclosure for the voltage operating points as shown in FIG. 9M. As shown in FIG. 9L, because the Sen Transformer 800 is configured to operate in the limited relative phase angle operation at β=240°, the compensating voltage unit 804 can be modified by removing the secondary windings associated with the phases outside of the relative phase angle of interest. For example, for the compensating voltage unit 804 of FIG. 9L, the secondary windings 806a₁, 806c₁, 806a₂, 806b₂, and 806b₃, 806c₃ are made inactive during operation or can be omitted or removed from the transformer configuration. Omission or removal of the secondary windings from the transformer or making them inactive during operation can result in more thermal efficient operation of the Sen Transformer 800. Furthermore, omission and/or removal can lead to a reduction in size and cost of the transformer. The tap position for load tap changer LTC2 for the minimum active power flow operating point (0.6 pu in this particular example) of the Sen Transformer 800 is shown in FIG. 90. Only one tap changer is required for operation since two secondary windings, which correspond to phases outside of the limited phase angles are made inactive during operation or are removed or omitted from the transformer configuration as already discussed.

FIGS. 9P and 9Q illustrate modified sending-end voltages operating points and the respective active and reactive power flows (Pᵣ and Qᵣ) operating points for a limited relative phase angle operation at β=60°, which offers the maximum active power flow operating points.

FIGS. 9R and 9T illustrate the Sen Transformer of FIG. 8A for a limited relative phase angle operation at β=60° according to an exemplary embodiment of the present disclosure for the voltage operating points as shown in FIG. 9S when the applied voltage on the secondary windings 806_{b1}, 806_{c2}, and 806ₐ₃ is reversed using a switch 901. As shown in FIG. 9R, because the Sen Transformer 800 is configured to operate in the limited relative phase angle operation at β=60°, the compensating voltage unit 804 can be modified by removing the secondary windings associated with the phases outside of the phase angle of interest. For example, for the compensating voltage unit 804 of FIG. 9R, the secondary windings 806a₁, 806c₁, 806a₂, 806b₂, and 806b₃, 806c₃ are made inactive during operation or can be omitted or removed from the transformer configuration. The tap position for load tap changer LTC2 for the maximum active power flow operating point (1.4 pu in this particular example) of the Sen Transformer 800 is shown in FIG. 9U. Only one tap changer is required for operation since two secondary windings, which correspond to phases outside of the limited phase angles are made inactive during operation or are omitted or removed from the transformer configuration as already discussed.

FIGS. 9V and 9W illustrate modified sending-end voltages operating points and the respective active and reactive power flows (Pᵣ and Qᵣ) operating points for a limited relative phase angle operation in the range of β=00 to β=120° with doubling the maximum active power flow enhancement feature activated. FIG. 9W also shows that the maximum active power flow enhancement at the receiving end is 0.80 pu (from 1 pu to 1.8 pu) in this particular example.

FIGS. 9X and 9Z illustrate the Sen Transformer of FIG. 8A being configured for a limited relative phase angle operation in the range of β=0° to β=120° with doubling the maximum active power flow feature activated, according to an exemplary embodiment of the present disclosure for the voltage operating points as shown in FIG. 9Y. The tap positions for load tap changers LTC1, LTC2, and LTC3 for a double maximum active power flow enhancement operating point (1.8 pu in this particular example) of the Sen Transformer 800 are shown in FIGS. 9AA through 9AC.

FIG. 11 illustrates an exemplary winding layout and a distribution of Ampere-Turns at β=0° in accordance with an exemplary embodiment of the present disclosure. As shown in FIGS. 8D and 11, the primary windings A, B, and C and the secondary windings 806ₐ₁, 806_{b2}, and 806_{c3} associated with LTC1 are active; the LTC2 and LTC3 are set at their minimum tap positions. The magnetomotive force (mmf) is generated in the primary windings and applied across the secondary windings associated with LTC1.

FIG. 12 illustrates an exemplary winding layout and a distribution of Ampere-Turns at β=60° in accordance with an exemplary embodiment of the present disclosure. As shown in FIGS. 8D and 12, the primary windings A, B, and C and the secondary windings 806ₐ₁, 806_{b2}, and 806_{c3} associated with LTC1 and the secondary windings 806_{c1}, 806ₐ₂, and 806_{b3} associated with LTC3 are active; the LTC2 is set at its minimum tap position. The mmf is generated in the primary windings and applied across the secondary windings associated with LTC1 and LTC3.

FIG. 13 illustrates an exemplary winding layout and a distribution of Ampere-Turns at β=120° in accordance with an exemplary embodiment of the present disclosure. As shown in FIGS. 8D and 13, the primary windings A, B, and C and the secondary windings 806_{c1}, 806ₐ₂, and 806_{b3} associated with LTC3 are active; the LTC1 and LTC2 are set at their minimum tap positions. The mmf is generated in the primary windings and applied across the secondary windings associated with LTC3.

FIG. 14 illustrates an exemplary winding layout and a distribution of Ampere-Turns at β=180° in accordance with an exemplary embodiment of the present disclosure. As shown in FIGS. 8D and 14, the primary windings A, B, and C and the secondary windings 806_{c1}, 806ₐ₂, and 806_{b3} associated with LTC3 and the secondary windings 806_{b1}, 806C₂, and 806ₐ₃ associated with LTC2 are active; the LTC1 is set at its minimum tap position. The mmf is generated in the primary windings and applied across the secondary windings associated with LTC3 and LTC2.

FIG. 15 illustrates an exemplary winding layout and a distribution of Ampere-Turns at β=240° in accordance with an exemplary embodiment of the present disclosure. As shown in FIGS. 8D and 15, the primary windings A, B, and C and the secondary windings 806_{b1}, 806_{c2}, and 806ₐ₃ associated with LTC2 are active; the LTC1 and LTC3 are set at their minimum tap positions. The mmf is generated in the primary windings and applied across the secondary windings associated with LTC2.

FIG. 16 illustrates an exemplary winding layout and a distribution of Ampere-Turns at β=300° in accordance with an exemplary embodiment of the present disclosure. As shown in FIGS. 8D and 16, the primary windings A, B, and C and the secondary windings 806_{b1}, 806_{c2}, and 806ₐ₃ associated with LTC2 and the secondary windings 806ₐ₁, 806_{b2}, and 806_{c3} associated with LTC1 are active; the LTC3 is set at its minimum tap position. The mmf is generated in the primary windings and applied across the secondary windings associated with LTC2 and LTC1.

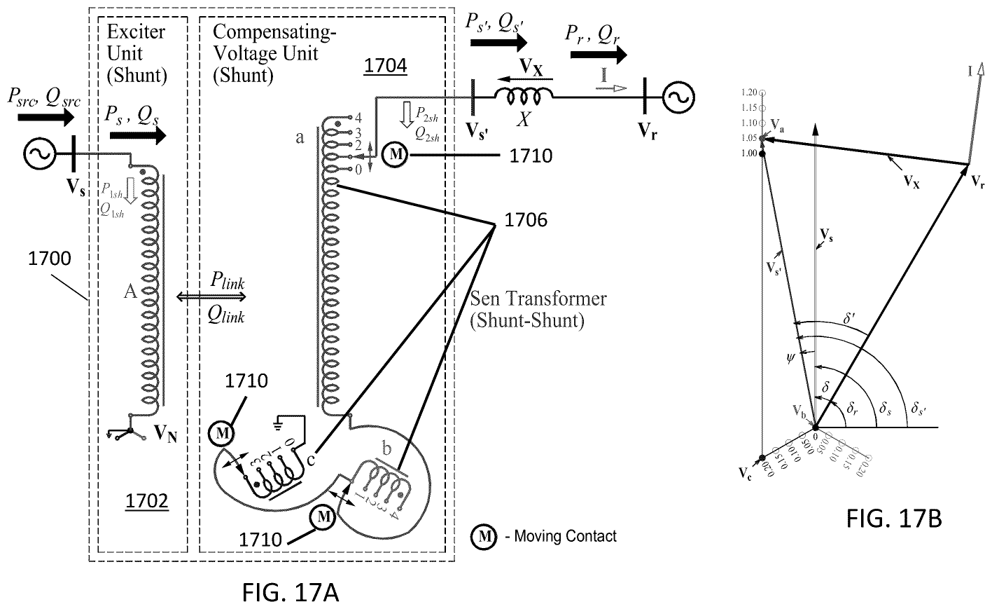

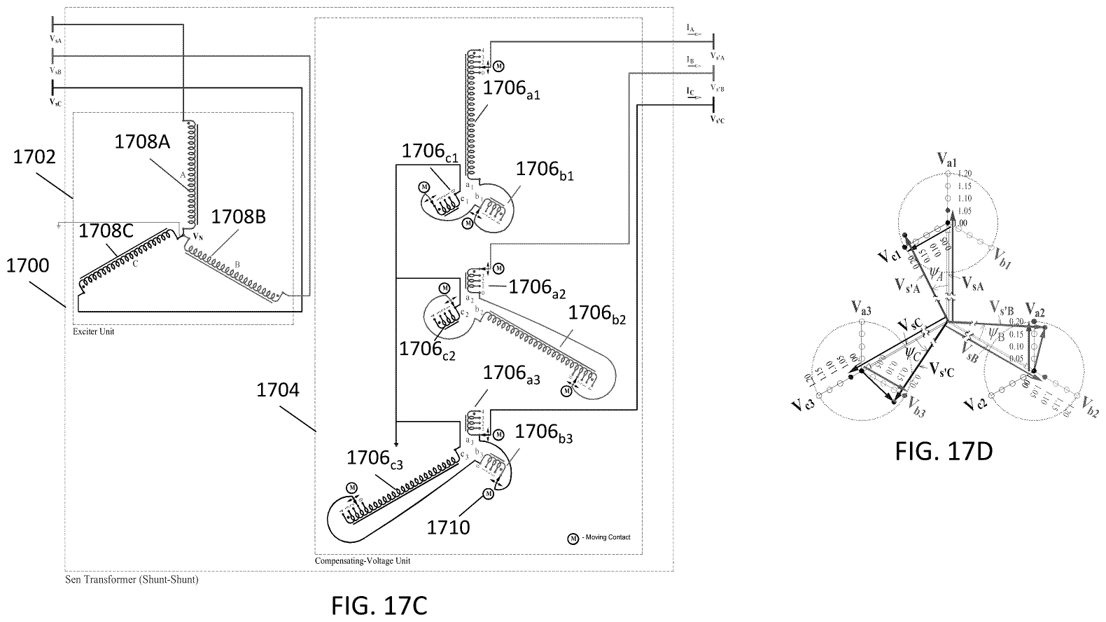

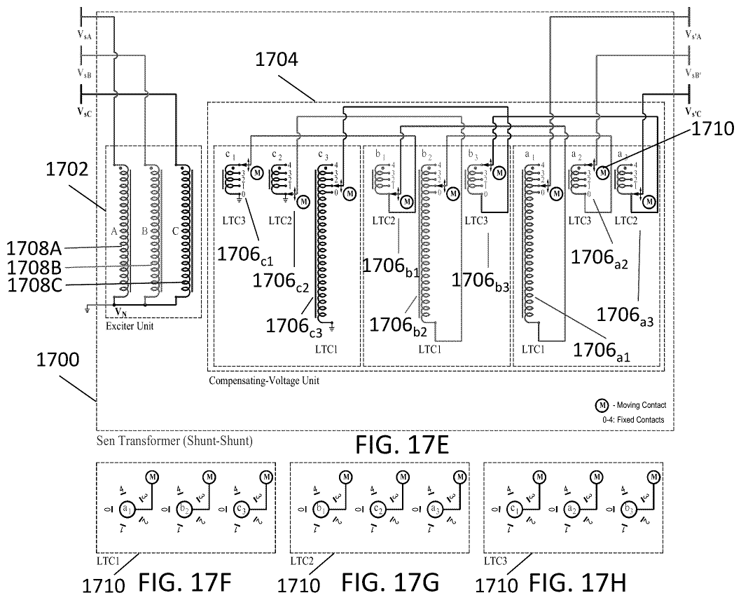

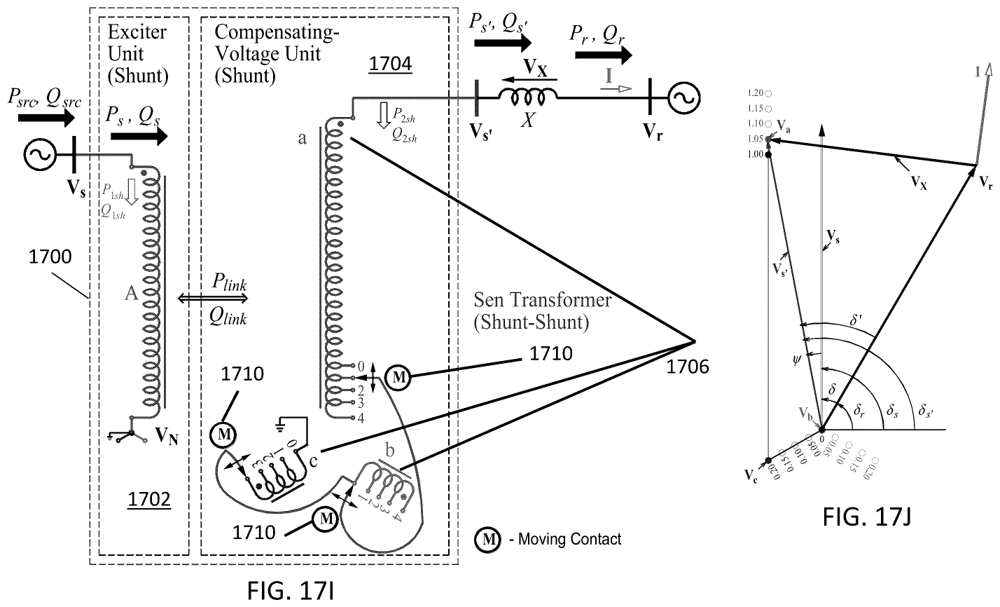

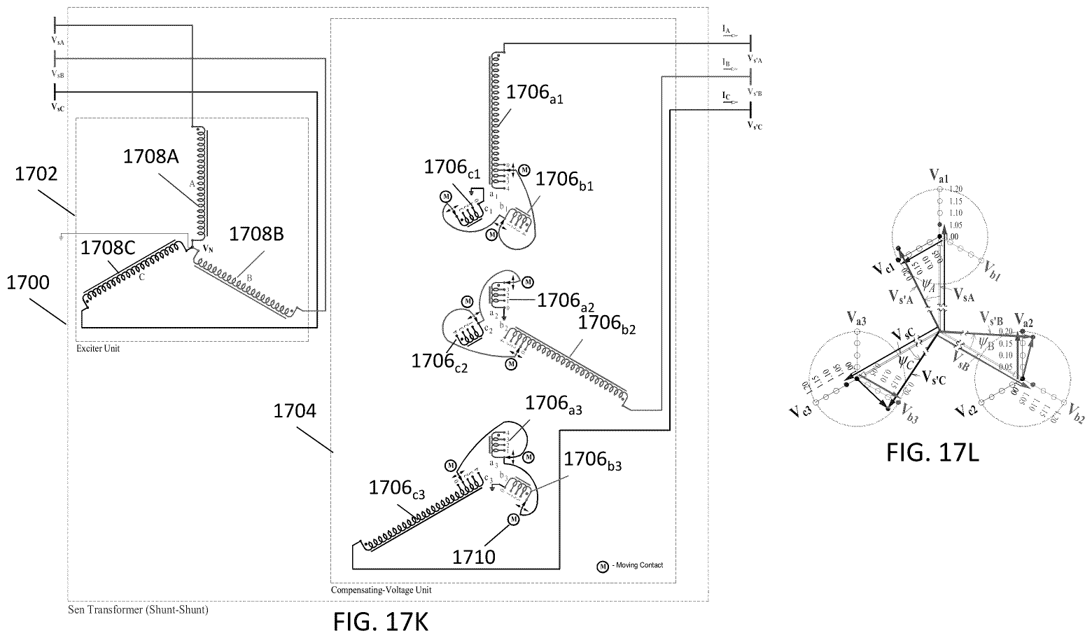

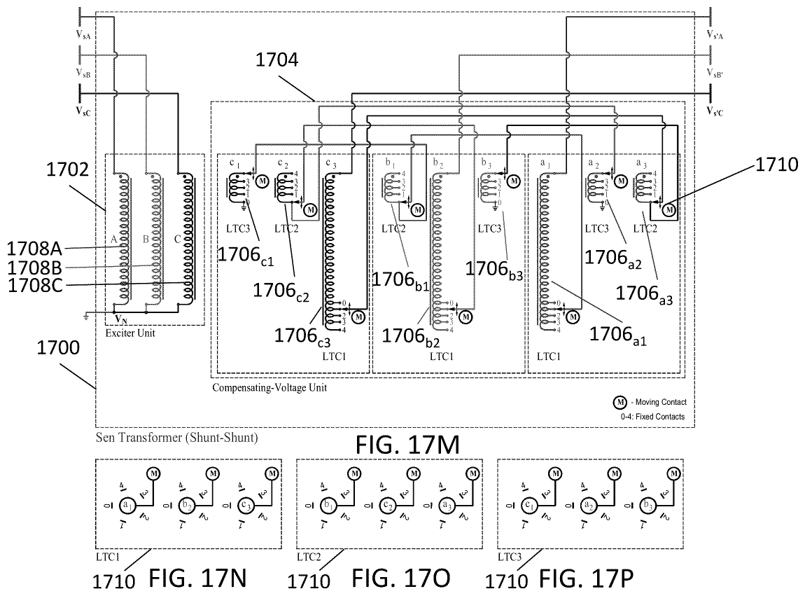

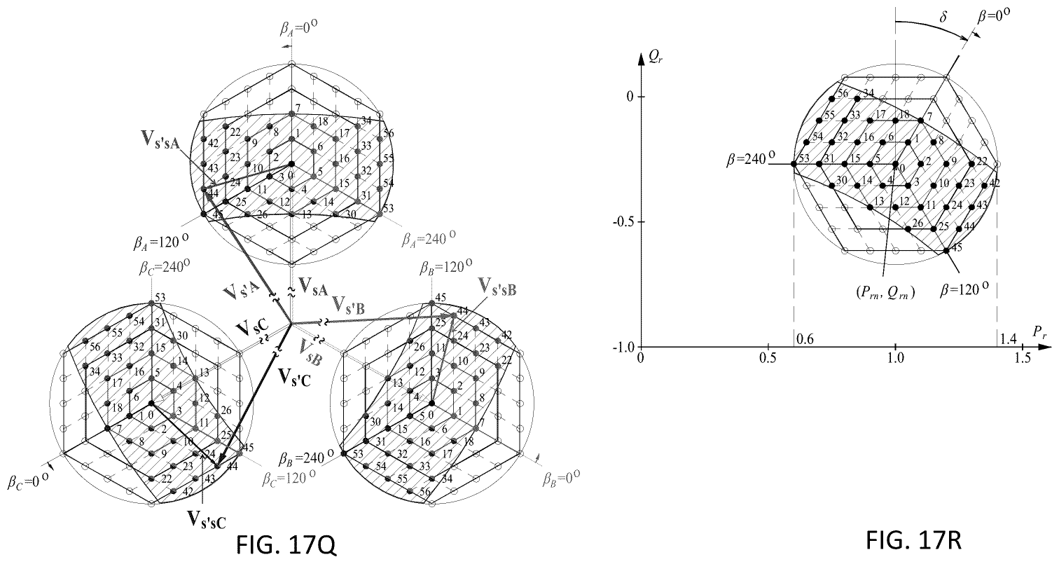

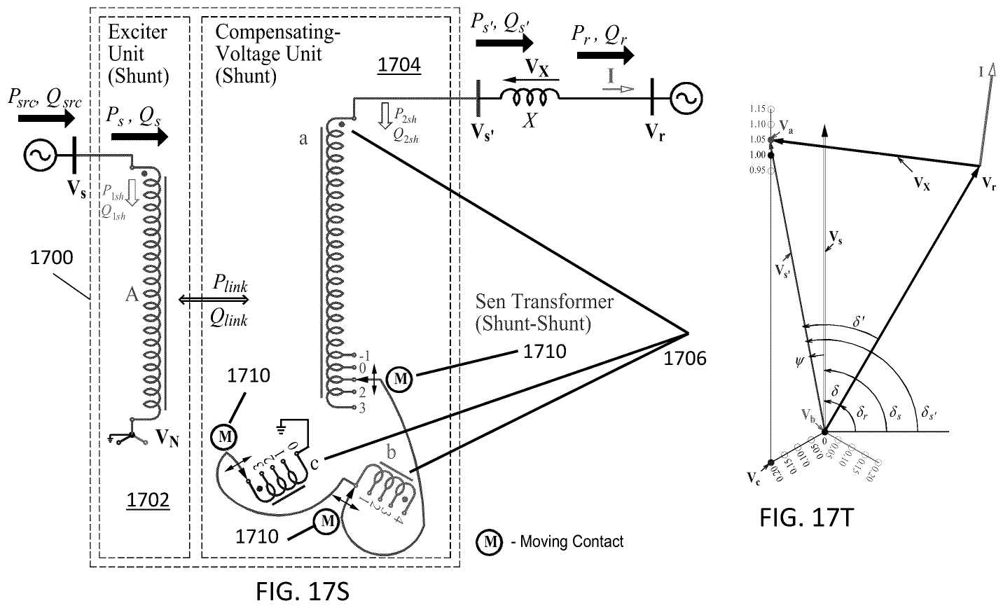

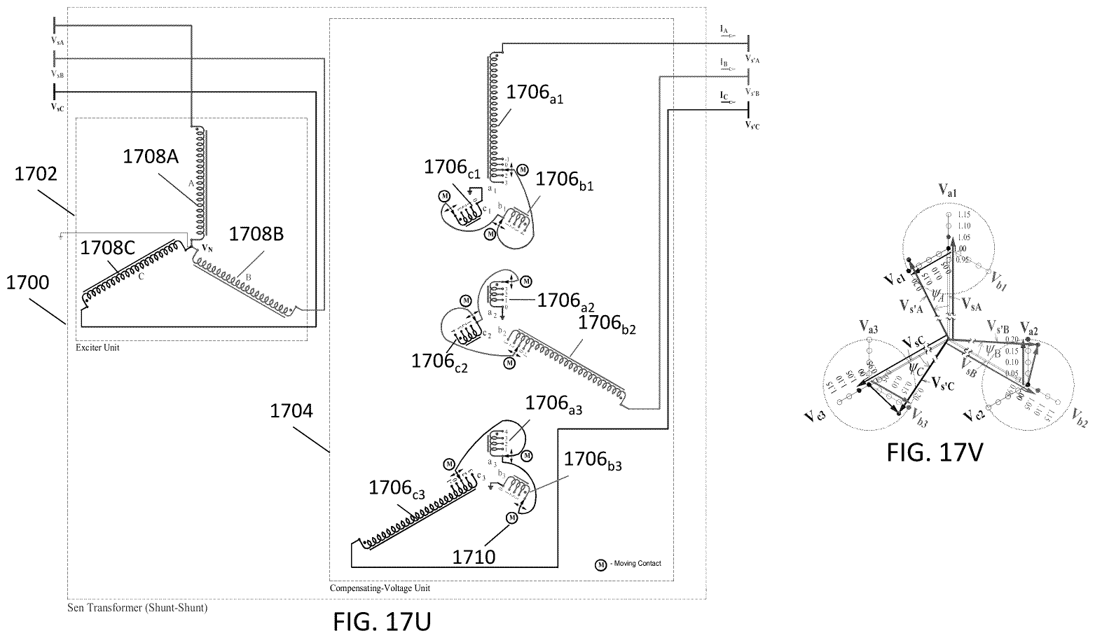

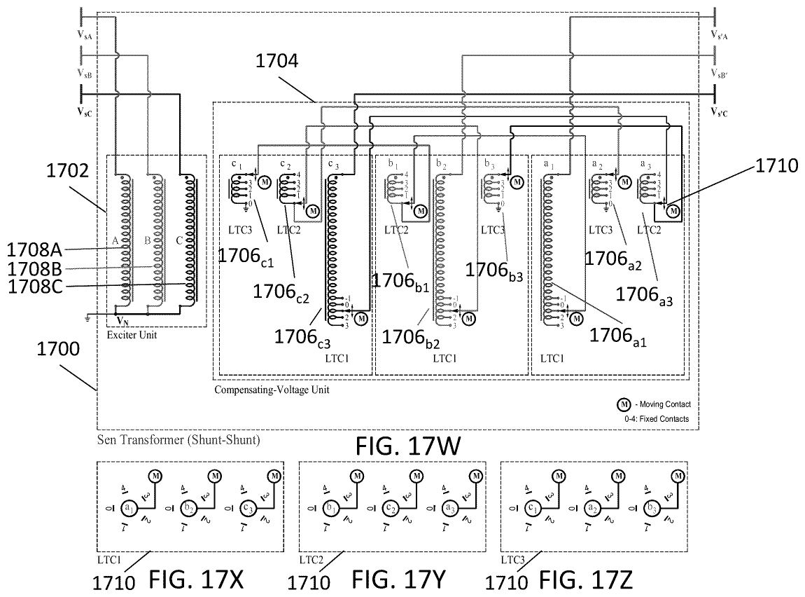

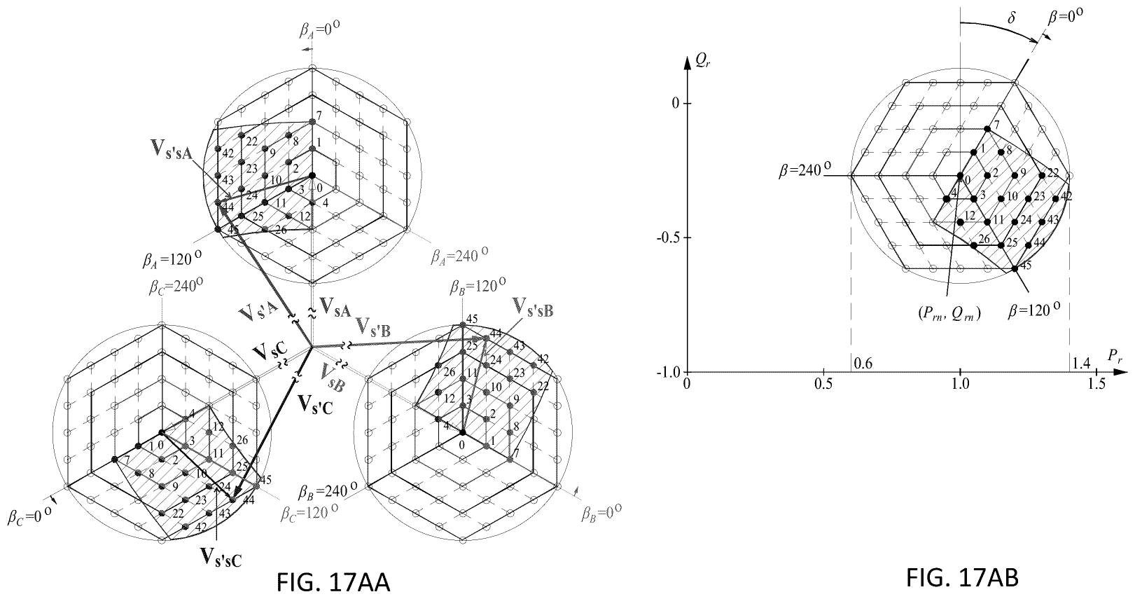

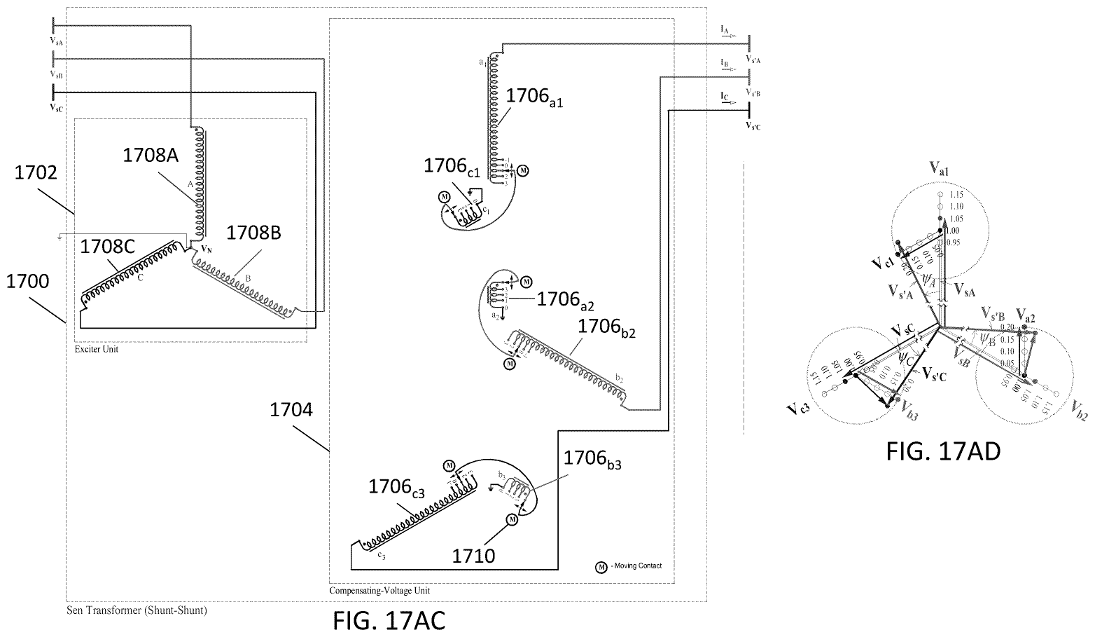

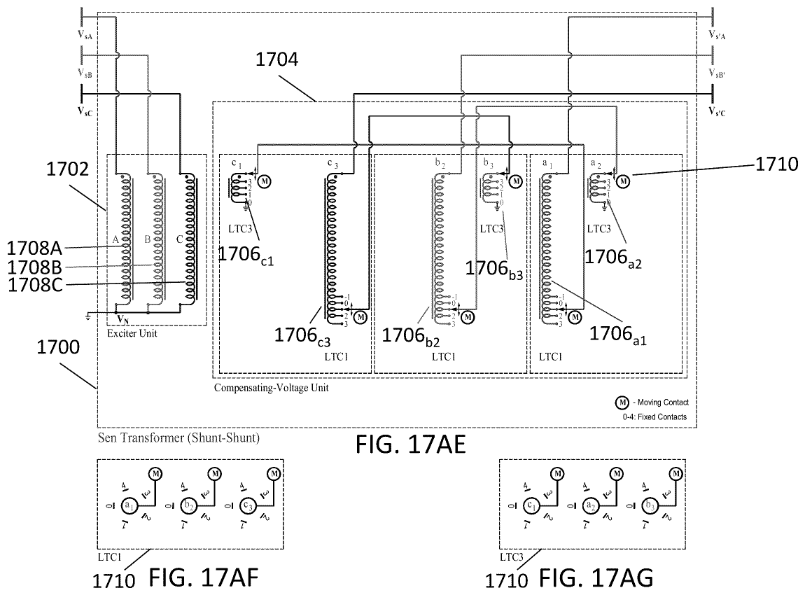

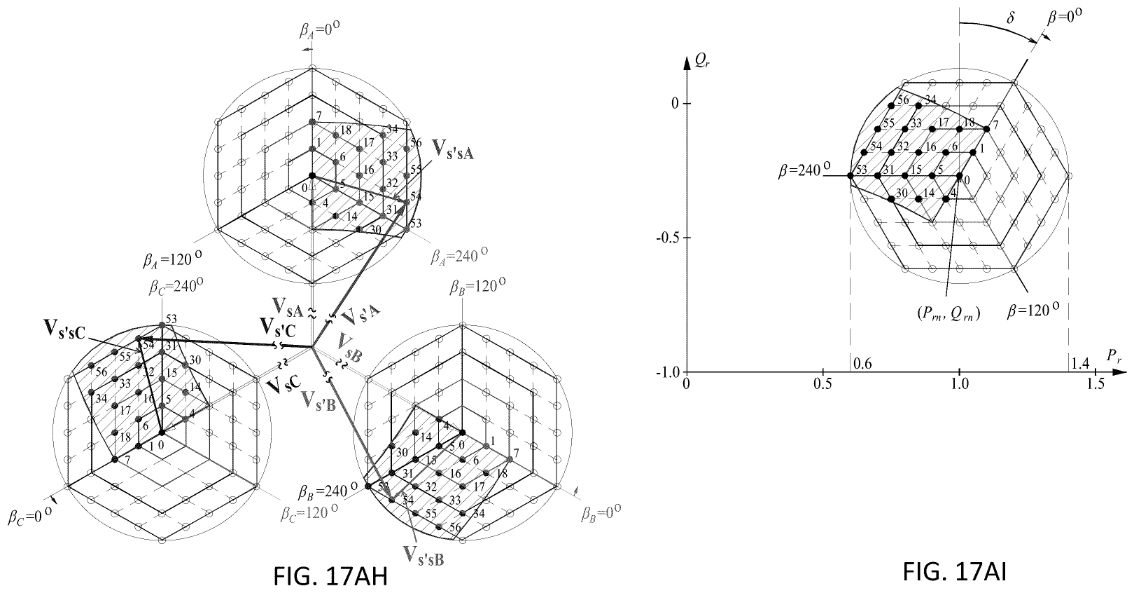

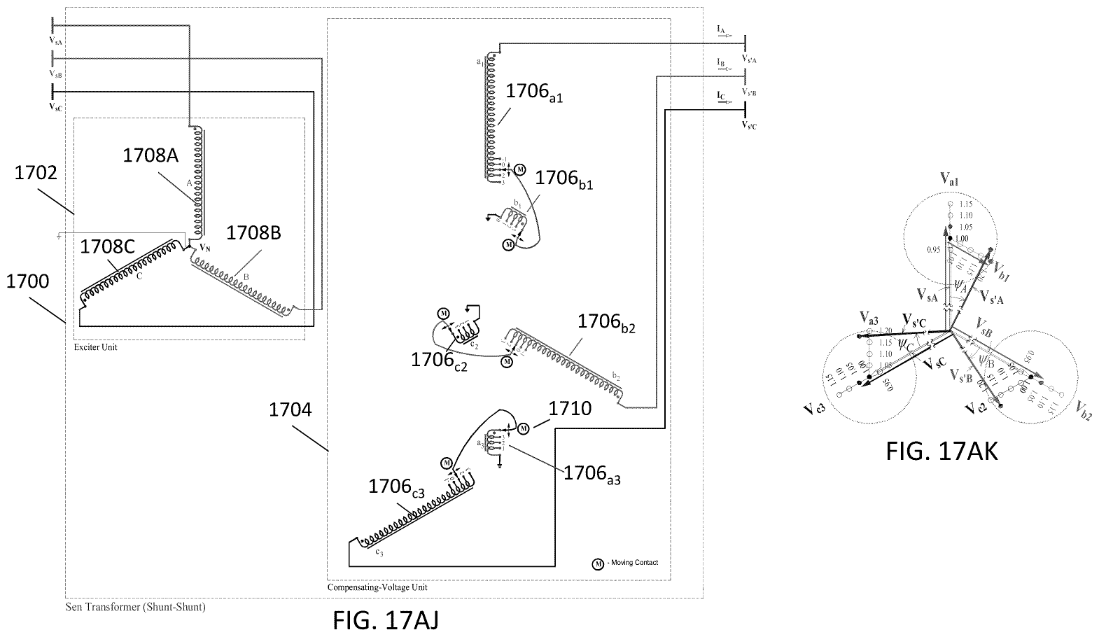

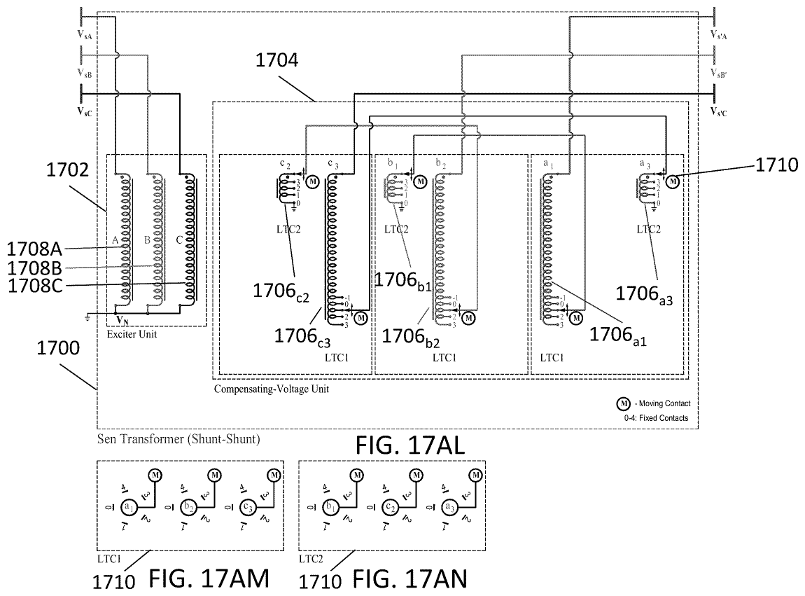

FIGS. 17A to 17AN illustrate a Sen Transformer arranged in a Shunt-Shunt configuration and having a winding arrangement according to an exemplary embodiment of the present disclosure. As shown in FIGS. 17A and 17B, the Sen Transformer 1700 includes an Exciter Unit 1702 and a Compensating-Voltage Unit 1704 arranged in a Shunt-Shunt configuration. FIG. 17A illustrates a Sen Transformer 1700, a single-phase Exciter Unit 1702 and a Compensating-Voltage Unit 1704 with three compensating windings 1706ₐ, 1706_{b}, 1706_{c} in the single-phase arrangement. FIGS. 17C and 17E illustrate the Sen Transformer of FIG. 17A in a three-phase arrangement. The Exciter Unit 1702 in FIGS. 17C and 17E consists of three shunt-Y connected primary windings 1708A, 1708B, and 1708C and the Compensating-Voltage Unit 1704 consists of nine (9) nine secondary windings (three windings in each phase: 1706ₐ₁, 1706ₐ₂, and 1706ₐ₃ on the core of the A phase; 1706_{b1}, 1706_{b2}, and 1706_{b3} on the core of the B phase; and 1706_{c1}, 1706_{c2}, and 1706_{c3} on the core of the C phase). The three-phase sending-end voltages (V_{sA}, V_{sB}, and V_{sC}) are applied to the Exciter Unit 1702. The Sen Transformer 1700 can achieve the power flow operating points of FIGS. 10A to 10E by summing three available induced voltages from the A, B, and C phases of the primary winding(s) of the Exciter Unit 1702 that are 120° apart. The Sen Transformers of FIGS. 17A, 17C, and 17E also include LTCs 1710 (LTC1, LTC2, and LTC3). In using LTCs, the effective number of turns in each compensating winding in each phase is varied and the composite voltage becomes variable in magnitude and phase angle.

According to an exemplary embodiment, the sending-end voltage for the Sen Transformer 1700 can be Vₛ=1 pu, the allowable magnitude (V) of the induced voltage (V) to be 0.2 pu and the voltage (x) across each tap of an LTC 1710 is 0.05 pu, there are N=4 taps associated with each secondary winding 1706a₁, 1706a₂, 1706a₃, 1706b₁, 1706b₂, 1706b₃, 1706c₁, 1706c₂, and 1706c₃. Therefore, each of the taps in LTC2 and LTC3 is set at 0, 1, 2, 3 or 4; the corresponding secondary winding is active by 0, 5 10, 15, or 20%, respectively, and contributes 0.0, 0.05, 0.10, 0.15, or 0.20 pu toward forming the compensating voltage. However, each of the taps in LTC1 is set at 0, 1, 2, 3, or 4; the corresponding secondary winding is active by 100, 105 110, 115, or 120%, respectively, and contributes 1.00, 1.05, 1.10, 1.15, or 1.20 pu toward forming the compensating voltage V_{s′A}, V_{s′B}, and V_{s′C}.

The composite voltage (V_{s′}) can be at any phase angle with the prevailing line current (I). Therefore, shunt-exchanged active and reactive powers (P₂ₛₕ and Q₂ₛₕ) with the line flow bidirectionally through the magnetic core. The compensating voltage (V_{s′}), being at any phase angle with the prevailing line current, acts as an Impedance Regulator (IR). Note that the exciter exchanges active and reactive powers (P₁ₛₕ and Q₁ₛₕ) with the line and flow bidirectionally through the magnetic core.

As shown in FIGS. 17E to 17H, each of the secondary windings (1706ₐ₁, 1706_{b2}, and 1706_{c3}) is tapped at the same number of turns through LTC1; each of the windings (1706_{b1}, 1706_{c2}, and 1706ₐ₃) is tapped at the same number of turns through LTC2; and each of the windings (1706_{c1}, 1706ₐ₂, and 1706_{b3}) is tapped at the same number of turns through LTC3. However, the number of turns in the respective sets of secondary windings for LTC1, LTC2, and LTC3, can be different from each other.

As shown in FIGS. 17B and 17D, by choosing the number of turns from each of the three windings through three LTCs (LTC1, LTC2, and LTC3) and, therefore, the magnitudes of the components of the three 120° phase-shifted induced voltages, the compensating voltage (V_{s′}) in any phase is derived from the phasor sum of the voltages induced in a three-phase secondary winding set (1706ₐ₁, 1706_{b1}, and 1706_{c1} for compensation in the A phase; 1706ₐ₂, 1706_{b2}, and 1706_{c2} for compensation in the B phase; and 1706ₐ₃, 1706_{b3}, and 1706_{c3} for compensation in the C phase).

According to an exemplary embodiment, each of the taps in LTC1, LTC2, and LTC3 can be set at 0, 1, 2, 3, or 4. Each of the secondary windings associated with LTC2 and LTC3 can be active by 0, 5 10, 15, or 20%, respectively and contribute 0.0, 0.05, 0.10, 0.15, or 0.20 pu toward forming the compensating voltage. At the same time, each of the secondary windings associated with LTC1 is active by 100, 105 110, 115, or 120%, respectively and contributes 1.00, 1.05, 1.10, 1.15, or 1.20 pu toward forming the compensating voltage V_{s′A}, V_{s′B}, and V_{s′C}.

Based on the exemplary winding configuration of FIG. 8A, the Sen Transformer 1700 operates according to the following:
when ψ=0° and V_{s′}>Vₛ, only LTC1 is required to operate;
when ψ=0° and V_{s′}<Vₛ, only LTC2 and LTC3 are required to operate; where ψ_{A}, ψ_{B}, and ψ_{C} are the phase-shift angle of the modified sending-end voltages with respect to the sending-end voltage in A, B, and C phases.

As shown in FIGS. 17E and 11, when selecting an operating point having a phase-shift angle of 0° and V_{s′}>Vₛ, the primary windings A, B, and C and the secondary windings 1706ₐ₁, 1706_{b2}, and 1706_{c3} associated with LTC1 of Sen Transformer 1700 are active (i.e., tap position 1, 2, 3, or 4); the LTC2 and LTC3 are set at their minimum tap positions (i.e., tap position 0). The magnetomotive force (mmf) is generated in the primary windings and applied across the secondary windings associated with LTC1.

As shown in FIGS. 17E and 12, when selecting an operating point having a phase-shift angle of 2.42° or 4.72° or 6.89° or 8.95°, the primary windings A, B, and C and the secondary windings 1706ₐ₁, 1706_{b2}, and 1706_{c3} associated with LTC1 and the secondary windings 1706_{c1}, 1706ₐ₂, and 1706_{b3} associated with LTC3 are active; the LTC2 is set at its minimum tap position. The mmf is generated in the primary windings and applied across the secondary windings associated with LTC1 and LTC3.

As shown in FIGS. 17E and 13, when selecting an operating point having a phase-shift angle of 2.54° or 5.21° or 7.99° or 10.89°, the primary windings A, B, and C and the secondary windings 1706_{c1}, 1706ₐ₂, and 1706_{b3} associated with LTC3 are active; the LTC1 and LTC2 are set at their minimum positions. The mmf is generated in the primary windings and applied across the secondary windings associated with LTC3.

As shown in FIGS. 17E and 14, when selecting an operating point having a phase-shift angle of 0° and V_{s′}<Vₛ, the primary windings A, B, and C and the secondary windings 1706_{c1}, 1706ₐ₂, and 1706_{b3} associated with LTC3 and the secondary windings 1706b₁, 1706c₂, and 1706a₃ associated with LTC2 are active; the LTC1 is set at its minimum tap position. The mmf is generated in the primary windings and applied across the secondary windings associated with LTC3 and LTC2.

As shown in FIGS. 17E and 15, when selecting an operating point having a phase shift angle of −2.54° or −5.21° or −7.99° or −10.89°, the primary windings A, B, and C and the secondary windings 1706_{b1}, 1706_{c2}, and 1706ₐ₃ associated with LTC2 are active; the LTC1 and LTC3 are set at their minimum tap positions. The mmf is generated in the primary windings and applied across the secondary windings associated with LTC2.

As shown in FIGS. 17E and 16, when selecting an operating point having a phase shift angle of −2.42° or −4.72° or −6.89° or −8.95°, the primary windings A, B, and C and the secondary windings 1706_{b1}, 1706_{c2}, and 1706ₐ₃ associated with LTC2 and the secondary windings 1706ₐ₁, 1706_{b2}, and 1706_{c3} associated with LTC1 are active; the LCT3 is set at its minimum tap position. The mmf is generated in the primary windings and applied across the secondary windings of associated with LTC2 and LTC1.

FIG. 17I illustrates the Sen Transformer 1700 being configured for modified sending-end voltages with the same operating point as shown in FIG. 17A. As shown in FIG. 17I, all the taps of compensating voltage windings 1706a, 1706b and 1706c of the compensating voltage unit 1704 are configured to operate closer to ground potential. This configuration can be contrasted with the transformer configuration shown in FIG. 17A; while the taps of compensating voltage windings 1706b and 1706c are configured to operate closer to ground potential as shown in FIG. 17A, the taps of compensating voltage winding 1706a of the compensating voltage unit 1704 are configured to operate closer to ground potential as well, not closer to line potential as shown in FIG. 17A. Both FIGS. 17A and 17I are set up for operation at the same operating point shown in the corresponding phasor diagrams of FIG. 17B and FIG. 17J. As discussed with regard to the transformer of FIG. 17A, moving the contacts of compensating voltage winding 1706a (LTC1) to a higher tap position (e.g., 0→1, 1→2, 2→3, 3→4, etc.,) in a direction toward the dot increases the compensating voltage in winding 1706a of the compensating voltage unit 1704. The transformer of FIG. 17I operates differently, however, in that moving the contacts of compensating voltage winding 1706a (LTC1) to a higher tap position (e.g., 0→1, 1→2, 2→3, 3→4, etc.,) in a direction away from the dot increases the compensating voltage in winding 1706a of the compensating voltage unit 1704. However, both FIGS. 17A and 17I show that moving the contacts of compensating voltage windings 1706b and 1706c (LTC2 and LTC3) to a higher tap position (e.g., 0→1, 1→2, 2→3, 3→4, etc.,) in a direction towards the dot increases the compensating voltage in windings b and c of the compensating voltage unit 1704. That is, in FIG. 17A the compensating voltage is increased in each of the secondary windings by moving the contacts of the LTC1, LTC2, and LTC3 tap positions in the same direction toward the dot. For the same operating points using the transformer of FIG. 17I, the compensating voltage is increased by changing the direction of tap movement for LTC1 to a higher tap position away from the dot to be different from the corresponding directional movement to a higher tap position for LTC2 and LTC3 toward the dot.

FIGS. 17K and 17M illustrate the Sen Transformer of FIG. 17I in a three-phase arrangement for the arbitrary voltage operating points as shown in FIG. 17L. The tap positions for load tap changers LTC1, LTC2, and LTC3 for the arbitrary operating point of the Sen Transformer 1700 are shown in FIGS. 17N through 17P. For the compensating voltage unit 1704, the compensating voltage of secondary windings 1706a₁, 1712b₂, and 1714c₃ can be increased by moving the contacts of LTC1 to a higher tap position (e.g., 0→1, 1→2, 2→3, 3→4, etc.,) in a direction away from the dot. For secondary windings 1706b₁, 1706c₁, 1706a₂, 1706c₂, 1706a₃, and 1706b₃ the compensating voltage can be increased by moving the contacts of LTC2, and LTC3 to a higher tap position (e.g., 0→1, 1→2, 2→3, 3→4, etc.,) in a direction towards the dot.

FIGS. 17Q and 17R illustrate modified sending-end voltages operating points and the respective active and reactive power flows (Pᵣ and Qᵣ) operating points, numbered 0 through 60, in accordance with an exemplary embodiment of the present disclosure with a 10% allowable voltage upper and lower limits.

FIG. 17S shows each of the LTC1 taps for the transformer configuration of FIG. 17I being set at −1, 0, 1, 2, or 3; the corresponding secondary winding is active by 95, 100, 105, 110, or 115%, respectively, and contributes 0.95, 1.00, 1.05, 1.10, or 1.15 pu toward forming the compensating voltage V_{s′A}, V_{s′B}, and V_{s′C}. The operating point as shown in FIG. 17T is the same as that in FIG. 17B or FIG. 17J.

FIGS. 17U and 17W illustrate the winding configuration of the Sen Transformer of FIG. 17S in a three-phase arrangement for the voltage operating points as shown in FIG. 17V. The tap positions for load tap changers LTC1, LTC2 and LTC3 for an arbitrary operating point of the Sen Transformer 1700 are shown in FIGS. 17X through 17Z. The secondary windings in each phase are configured to generate the modified sending-end voltages as already discussed in FIG. 17I.

FIGS. 17AA and 17AB illustrate a set of modified sending-end voltages operating points and the respective active and reactive power flows (Pᵣ and Qᵣ) operating points, in accordance with an exemplary embodiment of the present disclosure, in the power flow increase region. As shown in FIGS. 17AA and 17AB, power flow increase region is operable in the relative phase angle range of approximately β=0° to β=120°.

FIGS. 17AC and 17AE illustrate the Sen Transformer in a three-phase arrangement for the voltage operating point as shown in FIG. 17AD, requiring only six compensating secondary windings. Based on the winding configuration of the compensating voltage unit 1704, the phase angle range also corresponds to a power flow increase region. Because the Sen Transformer 1700 is configured to operate in a limited phase angle range as shown FIGS. 17AA and 17AB, the compensating voltage unit 1704 can be modified by removing or making inactive the secondary windings associated with the phases outside of the phase angle range of interest. For example, for the compensating voltage unit 1704 of FIG. 17AC, the secondary windings 1706b₁, 1706c₂, and 1706a₃ are made inactive or can be omitted or removed from the transformer configuration. The inactive secondary windings are grouped with LTC2. The tap positions for load tap changers LTC1 and LTC3 for an arbitrary operating point of the Sen Transformer 1700 are shown in FIGS. 17AF through 17AG. Only two tap changers are required for operation since one secondary winding corresponding to phases outside of the limited range of phase angles of interest is made inactive during operation or is omitted or removed from the transformer configuration as already discussed.

FIGS. 17AH and 17AI illustrate a set of modified sending-end voltages operating points and the respective active and reactive power flows (Pᵣ and Qᵣ) operating points, in accordance with an exemplary embodiment of the present disclosure, in the power flow decrease region. As shown in FIGS. 17AH and 17AI, power flow decrease region is operable in the relative phase angle range of approximately β=240° to β=360°.

FIGS. 17AJ and 17AL illustrate the Sen Transformer in a three-phase arrangement for the voltage operating point as shown in FIG. 17AK, requiring only six compensating secondary windings. Based on the winding configuration of the compensating voltage unit 1704, the phase angle range also corresponds to a power flow decrease region. Because the Sen Transformer 1700 is configured to operate in a limited phase angle range as shown in FIGS. 17AH and 17AI, the compensating voltage unit 1704 can be modified by removing or making inactive the secondary windings associated with the phases outside of the phase angle range of interest. For example, for the compensating voltage unit 1704 of FIG. 17AJ, the secondary windings 1706c₁, 1706a₂, and 1706b₃ are made inactive or can be omitted or removed from the transformer configuration. The inactive secondary windings are grouped with LTC3. The tap positions for load tap changers LTC1 and LTC2 for an arbitrary operating point of the Sen Transformer 1700 are shown in FIGS. 17AM through 17AN. Only two tap changers are required for operation since one secondary winding corresponding to phases outside of the limited range of phase angles of interest is made inactive during operation or is omitted or removed from the transformer configuration as already discussed.

Controlling power flow in one line using a Power Flow Controller with a shunt-series or shunt-shunt configuration has a side effect, which is the neighboring lines need to adjust their power flows to keep the overall power flow from the sources to loads unchanged. However, the power from one line can be transferred precisely to another line through a series-series configuration without altering power flow in any other line.

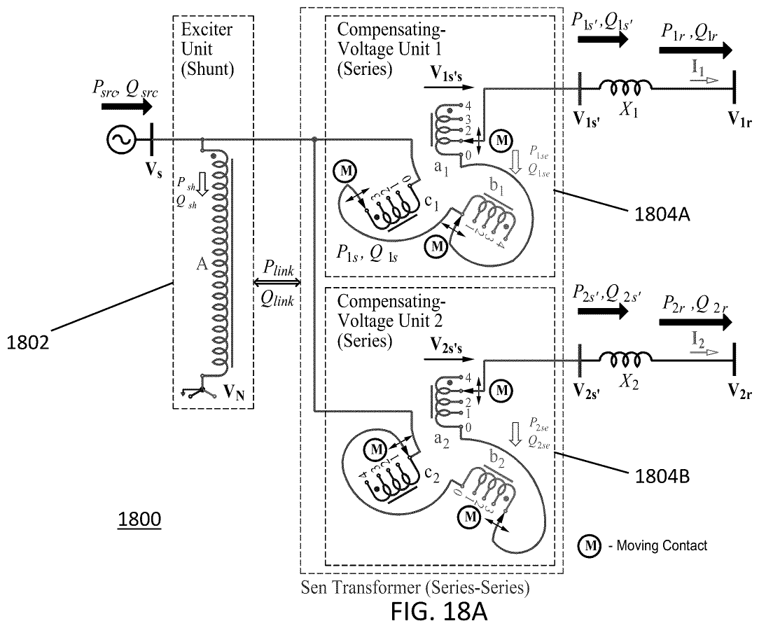

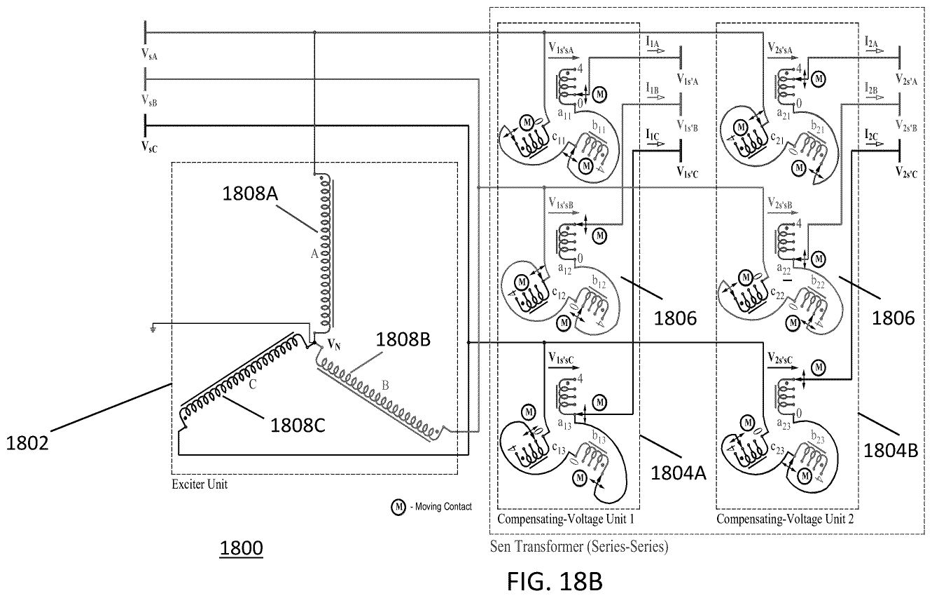

FIG. 18A illustrates a single-line diagram of a Sen Transformer with a series-series configuration in accordance with an exemplary embodiment of the present disclosure. As shown in FIG. 18A, the Sen Transformer 1800 includes an Exciter Unit 1802 and two Compensating-Voltage Units 1804A and 1804B connected in series with the Exciter Unit 1802. Each compensating voltage in the “leader” lines is of any magnitude within its allowable limit and at any phase angle with respect to the line voltage, as well as the prevailing line current, so that the active and reactive power flows in that line can be controlled independently as desired. Moreover, each series-compensating voltage in the “follower” lines is of specific magnitude and phase angle with respect to the prevailing line current, so that the active and reactive powers from the “leader” lines are transferred bidirectionally to the “follower” lines. This technique provides a desirable power flow management for a multiline transmission system by decreasing the power flow in the overloaded lines and increasing it in the underloaded lines with little impact on the other uncompensated lines.

FIG. 18B illustrates a Sen Transformer 1800 having a Series-Series connection between the Exciter Unit 1802 and the Compensating-Voltage Units 1804A and 1804B. As shown in FIG. 18B, the line voltage (Vₛ) is applied to a shunt-connected three-phase transformer's Y-connected primary windings 1808A, 1808B, and 1808C in the Exciter Unit 1802. In the Compensating-Voltage Unit 1804A having a total of nine secondary windings (1806ₐ₁₁, 1806ₐ₁₂, and 1806ₐ₁₃ on the core of the A phase; 1806_{b11}, 1806_{b12}, and 1806_{b13} on the core of the B phase; and 1806_{c11}, 1806_{c12}, and 1806_{c13} on the core of the C phase) derive a three-phase compensating voltage, each phase of which is a phasor sum of the voltages induced in a three-winding set (1806ₐ₁₁, 1806_{b11}, and 1806_{c11} for compensating voltage in the A phase; 1806ₐ₁₂, 1806_{b12}, and 1806_{c12} for compensating voltage in the B phase; and 1806ₐ₁₃, 1806_{b13}, and 1806_{c13} for compensating voltage in the C phase). By choosing the number of turns from each of the three windings via a respective LTC control for each group (LTC1, LTC2, and LTC3), and therefore, the magnitudes of the components of the three 120° phase-shifted induced voltages, the composite compensating voltage magnitude and the relative phase angle with respect to the line voltage can be selected. In the Compensating-Voltage Unit 1804B having a total of nine secondary windings (1806ₐ₂₁, 1806ₐ₂₂, and 1806ₐ₂₃ on the core of the A phase; 1806_{b21}, 1806_{b22}, and 1806_{b23} on the core of the B phase; and 1806_{c21}, 1806_{c22}, and 1806_{c23} on the core of the C phase) derive a three-phase compensating voltage, each phase of which is a phasor sum of the voltages induced in a three-winding set (1806ₐ₂₁, 1806_{b21}, and 1806_{c21} for compensating voltage in the A phase; 1806ₐ₂₂, 1806_{b22}, and 1806_{c22} for compensating voltage in the B phase; and 1806ₐ₂₃, 1806_{b23}, and 1806_{c23} for compensating voltage in the C phase). By choosing the number of turns from each of the three windings via a respective LTC control for each group (LTC1, LTC2, and LTC3), and therefore, the magnitudes of the components of the three 120° phase-shifted induced voltages, the composite compensating voltage magnitude and the relative phase angle with respect to the line voltage can be selected.

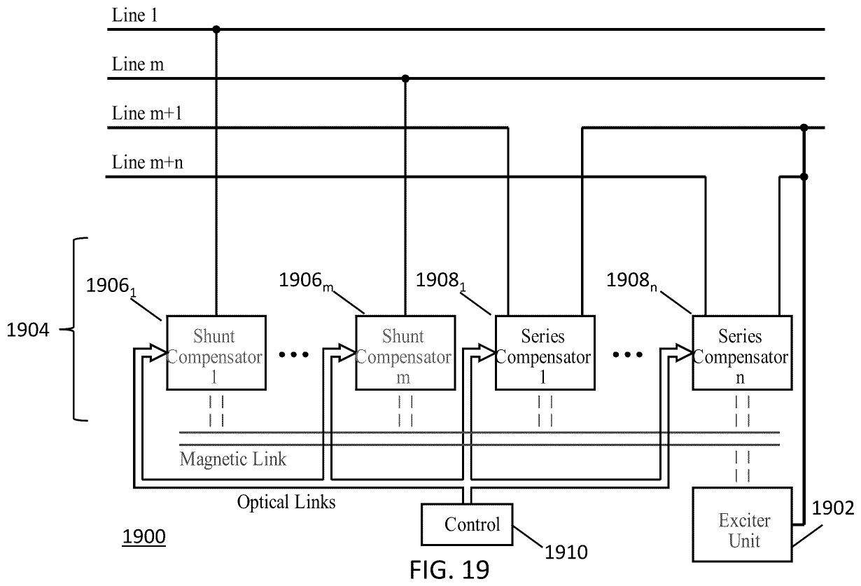

FIG. 19 illustrates a Generalized Sen Transformer (GST) configured to generate both the shunt- and series-compensating voltages in a single unit in accordance with an exemplary embodiment of the present disclosure. As shown in FIG. 19, the GST 1900 includes an Exciter Unit 1902 and a Compensating-Voltage Unit 1904. The Compensating-Voltage Unit 1904 includes plural shunt compensator units 1906ₘ and plural series compensator units 1908ₙ. Each shunt- and series-compensator unit 1906ₘ and 1908ₙ, respectively, is connected to a respective power line. The series-compensator units 1908ₙ are configured to control the active and reactive power flows in each line independently and transfer the active and reactive powers from one or more “leader” lines to one or more “follower” lines. The shunt-compensator units 1906ₘ are configured to connect the isolated networks with different voltages and phase angles to control the active and reactive power flows in each line independently and transfer the active and reactive powers from one or more “leader” lines to one or more “follower” lines. Each of the series- and shunt-compensator units 1908ₙ and 1906ₘ is induced from an exciter voltage through transformer action. Therefore, any mismatch of active and reactive powers between various compensating voltages flows to the line that supplies the Exciter Unit 1902 of the GST 1900.

The control 1910 and/or control operation for switching the LTCs based on a desired operating point can be performed by a computing device. According to an exemplary embodiment, the computing device can include one or more processing devices such as a microprocessor, central processing unit, microcomputer, programmable logic unit or any other suitable hardware processing device as desired. The computing device can be configured with computer program code for performing the specialized functions described herein. The program code can be stored on a computer usable medium, which may refer to memories, such as the memory devices for the computing device, which can be memory semiconductors (e.g., DRAMs, etc.). These computer program products can be a tangible non-transitory means for providing software to the various hardware components of the respective devices as needed for performing the tasks associated with the exemplary embodiments described herein. The computer programs (e.g., computer control logic) or software can be stored in the memory device. According to an exemplary embodiment, the computer programs can also be received and/or remotely accessed via other components of the computing device such as receiver or receiving device. Such computer programs, when executed, can enable the processor to implement the present methods and exemplary embodiments discussed herein, and may represent controllers of the processor. Where the present disclosure is implemented using software, the software can be stored in a non-transitory computer readable medium and loaded into the computing device using a removable storage drive, an interface, a hard disk drive, or communications interface, etc., where applicable.

The one or more processors of the computing device can include one or more modules or engines configured to perform the functions of the exemplary embodiments described herein. Each of the modules or engines can be implemented using hardware and, in some instances, can also utilize software, such as program code and/or programs stored in memory. In such instances, program code may be compiled by the respective processors (e.g., by a compiling module or engine) prior to execution. For example, the program code can be source code written in a programming language that is translated into a lower-level language, such as assembly language or machine code, for execution by the one or more processors and/or any additional hardware components. The process of compiling can include the use of lexical analysis, preprocessing, parsing, semantic analysis, syntax-directed translation, code generation, code optimization, and any other techniques that may be suitable for translation of program code into a lower-level language suitable for controlling the computing device to perform the functions disclosed herein. It will be apparent to persons having skill in the relevant art that such processes result in the computing device being specially configured computing devices uniquely programmed to perform the functions discussed above.

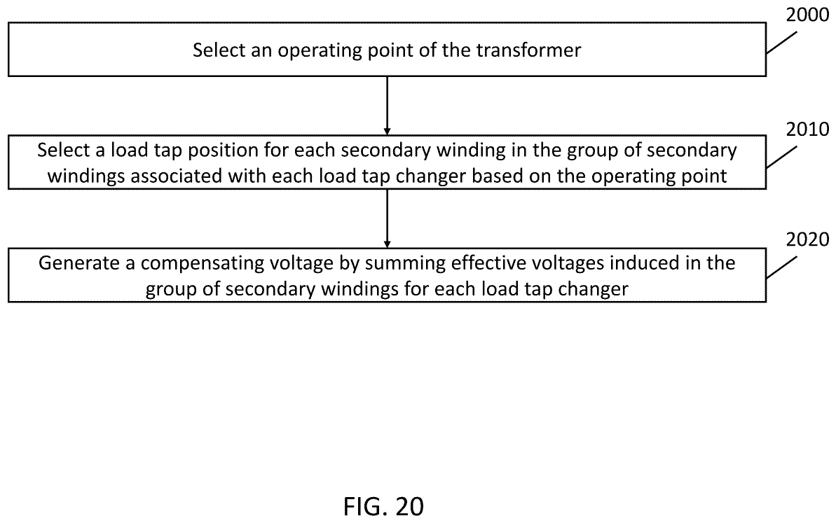

FIG. 20 illustrates a method of generating a compensating voltage in accordance with an exemplary embodiment of the present disclosure. The method can be implemented through a transformer configured as shown in FIG. 8A, 17C, 17K, 17U, 17AC, 17AJ, 18B, or 19. As shown in the aforementioned figures, the transformer has an Exciter Unit and a Compensating-Voltage Unit. The Exciter Unit includes a three-phase transformer with shunt Y-connected primary windings. The Compensating-Voltage Unit includes plural series-connected secondary windings that includes one secondary winding from each phase of the Exciter Unit. The Compensating-Voltage Unit also includes plural load tap changers. Each load tap changer is associated with a group of secondary windings that includes one secondary winding from each phase of the Exciter Unit. According to an exemplary embodiment, each secondary winding is allocated to a group of secondary windings, where each secondary winding is placed (i.e., located) at a same distance from an associated primary winding of the Exciter Unit. According to yet another exemplary embodiment all secondary windings and sub-windings between two consecutive taps in the Compensating-Voltage Unit and primary windings in the Exciter Unit have substantially similar heights. The sub-windings may or may not be interleaved. In executing the method, a controller is configured to select an operating point of the transformer (Step 2000). The operating point can be selected based on an input the controller (e.g., 1910) receives from an operator or user. FIGS. 10A to 10E illustrate various operating points for generating a compensating voltage according to one or more parameters of the transformer. According to another exemplary embodiment, the input can be automatically generated by an external computing system configured to monitor operation of power system and automatically select an operating point based on desired power flow control. Based on the selected operating point, the controller (e.g., 1910) selects a load tap position for each secondary winding in the group of secondary windings associated with each load tap changer based on the operating point (Step 2010). The Compensating-Voltage Unit of the transformer generates a compensating voltage by summing effective voltages induced in the group of secondary windings for each load tap changer (Step 2020). FIGS. 11 to 16 illustrate the resultant compensating voltage generated by the secondary windings of the Compensating-Voltage Unit for respective operating points. This operation can be repeated as conditions in the power line(s), grid, and/or desired compensating voltage change.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein.

What is claimed is:

1. A transformer that generates a compensating voltage, the transformer comprising:
an exciter unit; and
a compensating voltage unit,
the exciter unit including three single-phase transformers or a three-phase transformer with shunt Y-connected primary windings,
the compensating voltage unit including:
plural series-connected secondary windings that includes one secondary winding from each phase of the exciter unit; and
plural load tap changers, wherein each load tap changer is associated with a group of secondary windings that includes one secondary winding from each phase of the exciter unit, wherein each secondary winding in a group of secondary windings is located at a same distance from an associated primary winding of the exciter unit, wherein all windings have similar heights, and wherein each load tap changer is configured to vary an effective number of turns of the associated group of secondary windings by connecting to one of plural taps associated with each secondary winding according to a selected operating point.

2. The transformer of claim 1 comprising:
a shunt-series configuration, wherein the exciter unit and the compensating voltage unit are electrically connected.

3. The transformer of claim 1 comprising:
a shunt-shunt configuration, wherein the exciter unit and the compensating voltage unit are electrically isolated.

4. The transformer of claim 1, comprising:
a series-series configuration, wherein the exciter unit is connected to a transmission line and plural compensating voltage units, wherein each compensating voltage unit is electrically connected to one of the plural transmission lines.

5. The transformer of claim 1, wherein the compensating voltage is a sum of effective voltages induced by the plural secondary windings for each phase in the compensating voltage unit.

6. The transformer of claim 1, wherein the plural taps associated with each secondary winding are separated at x % intervals.

7. The transformer of claim 6, wherein x is an integer value such that x>0.

8. The transformer of claim 5, wherein based on an interval arrangement of a five plural taps, numbered 0, 1, 2, 3, and 4 and each tap is separated by 5%, the effective voltage in each secondary winding varies: the series compensating voltage varies in magnitude from 0 to 20% of the primary voltage and varies in a relative phase angle between 0° to 360°; the shunt compensating voltage varies in magnitude from 80 to 120% of the primary voltage and varies in a phase-shift angle between −ψ to +ψ.

9. The transformer of claim 1, wherein the load tap changers are configured as single-phase load tap changers, three single-phase load tap changers are connected to a same number of turns of the group of secondary windings.

10. The transformer of claim 1, wherein the load tap changers are configured as plural three-phase load tap changers, wherein each load tap changer is connected to a same number of turns of the group of secondary windings.

11. The transformer of claim 1, wherein the compensating unit further comprises:
a tertiary winding for each phase, wherein the tertiary windings for the three phases are delta-connected and only one terminal comes out of the transformer for grounding purposes.

12. The transformer of claim 11, wherein each tertiary winding is an innermost winding next to a core of the transformer.

13. The transformer of claim 11, wherein the tertiary winding is configured to permit circulation of zero-sequence current.

14. A method of generating a compensating voltage through a transformer having an exciter unit and a compensating voltage unit, including three single-phase transformers or a three-phase transformer with shunt Y-connected primary windings, the compensating voltage unit including: plural series-connected secondary windings that includes one secondary winding from each phase of the exciter unit; and plural load tap changers, wherein each load tap changer is associated with a group of secondary windings that includes one secondary winding from each phase of the exciter unit, wherein each secondary winding in a group of secondary windings is located at a same distance from an associated primary winding of the exciter unit, wherein all windings have similar heights, the method comprising:
selecting an operating point of the transformer;
selecting a load tap position for each secondary winding in the group of secondary windings associated with each load tap changer based on the operating point; and
generating a compensating voltage by summing effective voltages induced in the group of secondary windings for each load tap changer.

15. The method of claim 14, wherein based on the selected load tap position, each three-phase load tap changer varies a magnitude of the series compensating voltage and a relative phase angle of the series compensating voltage.

16. The method of claim 15, wherein each secondary winding has 5 total taps that are separated at 5% intervals, the method further comprising:
varying the magnitude of the series compensating voltage from 0% to 20% of the primary voltage.

17. The method of claim 15 further comprising:
varying the relative phase angle of the series compensating voltage between 0° and 360°.

18. The method of claim 15 further comprising:
varying the relative phase angle of the series compensating voltage between 0° and 120°; and
reversing, using an additional switch of the transformer, a voltage applied to the secondary windings to double a maximum active power flow enhancement at a relative phase angle of 60°.

19. The method of claim 17, wherein each load tap changer includes load tap positions 0, 1, 2, 3, and 4, the method comprising:
selecting the operating point having a relative phase angle of 0°;
setting a first load tap changer to connect load tap position 1, 2, 3, or 4 on each secondary winding;
setting a second load tap changer to connect load tap position 0 on each secondary winding; and
setting a third load tap changer to connect load tap position 0 on each secondary winding.

20. The method of claim 17, wherein each load tap changer includes load tap positions 0, 1, 2, 3, and 4, the method comprising:
selecting the operating point having a relative phase angle of 60°;
setting a first load tap changer to connect load tap position 1, 2, 3, or 4 on each secondary winding;
setting a second load tap changer to connect load tap position 0 on each secondary winding; and
setting a third load tap changer to connect load tap position 1, 2, 3, or 4 on each secondary winding.

21. The method of claim 17, wherein each load tap changer includes load tap positions 0, 1, 2, 3, and 4, the method comprising:
selecting the operating point having a relative phase angle of 120°;
setting a first load tap changer to connect load tap position 0 on each secondary winding;
setting a second load tap changer to connect load tap position 0 on each secondary winding; and
setting a third load tap changer to connect load tap position 1, 2, 3, or 4 on each secondary winding.

22. The method of claim 17, wherein each load tap changer includes load tap positions 0, 1, 2, 3, and 4, the method comprising:
selecting the operating point having a relative phase angle of 180°;
setting a first load tap changer to connect load tap position 0 on each secondary winding;
setting a second load tap changer to connect load tap position 1, 2, 3, or 4 on each secondary winding; and
setting a third load tap changer to connect load tap position 1, 2, 3, or 4 on each secondary winding.

23. The method of claim 17, wherein each load tap changer includes load tap positions 0, 1, 2, 3, and 4, the method comprising:
selecting the operating point having a relative phase angle of 240°;
setting a first load tap changer to connect load tap position 0 on each secondary winding;
setting a second load tap changer to connect load tap position 1, 2, 3, or 4 on each secondary winding; and
setting a third load tap changer to connect load tap position 0 on each secondary winding.

24. The method of claim 17, wherein each load tap changer includes load tap positions 0, 1, 2, 3, and 4, the method comprising:
selecting the operating point having a relative phase angle of 300°;
setting a first load tap changer to connect load tap position 1, 2, 3, or 4 on each secondary winding;
setting a second load tap changer to connect load tap position 1, 2, 3, or 4 on each secondary winding; and
setting a third load tap changer to connect load tap position 0 on each secondary winding.

25. The method of claim 14, wherein based on the selected load tap position, each three-phase load tap changer varies a magnitude of the shunt compensating voltage and a phase-shift angle of the shunt compensating voltage.

26. The method of claim 24, wherein each secondary winding has 5 total taps that are separated at 5% intervals, the method further comprising:
varying the magnitude of the shunt compensating voltage from 80 to 120% of the primary voltage.

27. The method of claim 24 further comprising:
varying the phase-shift angle of the shunt compensating voltage between −ψ to +ψ.

28. The method of claim 26, wherein each load tap changer includes load tap positions 0, 1, 2, 3, and 4, the method comprising:
selecting the operating point having a phase-shift angle of 0°;
setting a first load tap changer to connect load tap position 1, 2, 3, or 4 on each secondary winding;
setting a second load tap changer to connect load tap position 0 on each secondary winding; and
setting a third load tap changer to connect load tap position 0 on each secondary winding.

29. The method of claim 26, wherein each load tap changer includes load tap positions 0, 1, 2, 3, and 4, the method comprising:
selecting the operating point having a phase-shift angle of 2.42° or 4.72° or 6.89° or 8.95°;
setting a first load tap changer to connect load tap position 1, 2, 3, or 4 on each secondary winding;
setting a second load tap changer to connect load tap position 0 on each secondary winding; and
setting a third load tap changer to connect load tap position 1, 2, 3, or 4 on each secondary winding.

30. The method of claim 26, wherein each load tap changer includes load tap positions 0, 1, 2, 3, and 4, the method comprising:
selecting the operating point having a phase-shift angle of 2.54° or 5.21° or 7.99° or 10.89°;
setting a first load tap changer to connect load tap position 0 on each secondary winding;
setting a second load tap changer to connect load tap position 0 on each secondary winding; and
setting a third load tap changer to connect load tap position 1, 2, 3, or 4 on each secondary winding.

31. The method of claim 26, wherein each load tap changer includes load tap positions 0, 1, 2, 3, and 4, the method comprising:
selecting the operating point having a phase-shift angle of 0°;
setting a first load tap changer to connect load tap position 0 on each secondary winding;
setting a second load tap changer to connect load tap position 1, 2, 3, or 4 on each secondary winding; and
setting a third load tap changer to connect load tap position 1, 2, 3, or 4 on each secondary winding.

32. The method of claim 26, wherein each load tap changer includes load tap positions 0, 1, 2, 3, and 4, the method comprising:
selecting the operating point having a phase-shift angle of −2.54° or −5.21° or −7.99° or −10.89°;
setting a first load tap changer to connect load tap position 0 on each secondary winding;
setting a second load tap changer to connect load tap position 1, 2, 3, or 4 on each secondary winding; and
setting a third load tap changer to connect load tap position 0 on each secondary winding.

33. The method of claim 26, wherein each load tap changer includes load tap positions 0, 1, 2, 3, and 4, the method comprising:
selecting the operating point having a phase-shift angle of −2.42° or −4.72° or −6.89° or −8.95°;
setting a first load tap changer to connect load tap position 1, 2, 3, or 4 on each secondary winding;
setting a second load tap changer to connect load tap position 1, 2, 3, or 4 on each secondary winding; and
setting a third load tap changer to connect load tap position 0 on each secondary winding.

34. The method of claim 24 further comprising:
varying a phase-shift angle of a shunt compensating voltage between −ψ to +ψ when all taps of the compensating voltage unit are closer to ground potential for a most cost-saving configuration of the transformer.

35. The method of claim 24 further comprising:
varying a phase-shift angle of a shunt compensating voltage between −ψ to 0.

36. The method of claim 24 further comprising:
varying a phase-shift angle of a shunt compensating voltage between 0 to +ψ.
